(19) United States
(12) Patent Application Publication
(10) Pub. No.: US 2026/0149534 A1
(43) Pub. Date: May 28, 2026

(54) MULTIPLEXING AND BUNDLING TECHNIQUES FOR FEEDBACK COMMUNICATIONS

(71) Applicant: QUALCOMM Incorporated, San Diego, CA (US)

(72) Inventors: Mostafa KHOSHNEVISAN, San Diego, CA (US); Jing SUN, San Diego, CA (US); Morteza SOLTANI, San Diego, CA (US)

(21) Appl. No.: 18/960,965

(22) Filed: Nov. 26, 2024

(51) Int. Cl. H04L 1/1812; H04B 7/06; H04W 72/0446

(52) U.S. Cl. CPC H04L 1/1812; H04B 7/063; H04W 72/0446

(57) ABSTRACT

Various aspects of the present disclosure generally relate to wireless communication. In some aspects, a user equipment (UE) may receive configuration information that indicates whether a feedback communication is associated with a first type of feedback or a second type of feedback, where the feedback communication is associated with data received during one or more downlink intervals, and the configuration information is specific to an uplink interval. The UE may receive, during the one or more downlink intervals, one or more downlink messages. The UE may transmit, during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback. Numerous other aspects are described.

### FIELD OF THE DISCLOSURE

Aspects of the present disclosure generally relate to wireless communication and specifically relate to techniques, apparatuses, and methods associated with multiplexing and bundling techniques for feedback communications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A medium access control (MAC) layer of a protocol stack may implement a hybrid automatic repeat request (HARQ) protocol to provide a faster retransmission mechanism relative to other retransmission mechanisms, such as a radio link control (RLC) layer retransmission system. In some examples, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node and a user equipment (UE) (e.g., a downlink HARQ process), a UE and a network node (e.g., an uplink HARQ process), and/or a first UE and a second UE (e.g., a sidelink HARQ process). Thus, a HARQ process may be used for downlink communications, uplink communications, and/or sidelink communications. In some examples, and as part of a HARQ process, a network node may transmit information in downlink control information (DCI) that indicates, to a receiving device (e.g., a UE), which downlink transmission(s) and/or which uplink transmissions to process using a HARQ protocol. Additionally, or alternatively, and as part of the HARQ process, a first UE may transmit information in sidelink control information (SCI) that indicates, to a second UE, which sidelink transmission(s) to process using the HARQ protocol.

### SUMMARY

Some aspects described herein relate to a user equipment (UE) for wireless communication. The UE may include one or more memories and one or more processors coupled to the one or more memories. The one or more processors may be configured to receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The one or more processors may be configured to receive, from the network node during the one or more downlink intervals, one or more downlink messages. The one or more processors may be configured to transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to a network node for wireless communication. The network node may include one or more memories and one or more processors coupled to the one or more memories. The one or more processors may be configured to transmit, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The one or more processors may be configured to transmit, to the UE during the one or more downlink intervals, a one or more downlink messages. The one or more processors may be configured to receive, from the UE during the uplink interval, the feedback communication, wherein the feedback communication includes feedback indications associated with respective downlink messages of the one or more downlink messages in accordance with the first type of feedback or a single feedback indication associated with the one or more downlink messages in accordance with the second type of feedback.

Some aspects described herein relate to a method of wireless communication performed by a UE. The method may include receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The method may include receiving, from the network node during the one or more downlink intervals, one or more downlink messages. The method may include transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to a method of wireless communication performed by a network node. The method may include transmitting, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The method may include transmitting, to the UE during the one or more downlink intervals, a one or more downlink messages. The method may include receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to a non-transitory computer-readable medium that stores a set of instructions for wireless communication by a UE. The set of instructions, when executed by one or more processors of the UE, may cause the UE to receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The set of instructions, when executed by one or more processors of the UE, may cause the UE to receive, from the network node during the one or more downlink intervals, one or more downlink messages. The set of instructions, when executed by one or more processors of the UE, may cause the UE to transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to a non-transitory computer-readable medium that stores a set of instructions for wireless communication by a network node. The set of instructions, when executed by one or more processors of the network node, may cause the network node to transmit, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The set of instructions, when executed by one or more processors of the network node, may cause the network node to transmit, to the UE during the one or more downlink intervals, a one or more downlink messages. The set of instructions, when executed by one or more processors of the network node, may cause the network node to receive, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to an apparatus for wireless communication. The apparatus may include means for receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The apparatus may include means for receiving, from the network node during the one or more downlink intervals, one or more downlink messages. The apparatus may include means for transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Some aspects described herein relate to an apparatus for wireless communication. The apparatus may include means for transmitting, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The apparatus may include means for transmitting, to the UE during the one or more downlink intervals, a one or more downlink messages. The apparatus may include means for receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a time domain resource allocation (TDRA), in accordance with the present disclosure.

FIG. 4 is a diagram illustrating an example of hybrid automatic repeat request (HARQ) codebook transmissions, in accordance with the present disclosure.

FIG. 5 is a diagram of an example of slot offsets for feedback transmission with respect to an uplink carrier, in accordance with the present disclosure.

FIG. 6A is a diagram illustrating an example associated with interval offsets for feedback communication across a set of component carriers (CCs) that each separately apply multiplexed feedback or bundling feedback, in accordance with the present disclosure.

FIG. 6B is a diagram illustrating an example associated with interval offsets for feedback communication across a set of CCs that separately apply multiplexed feedback or bundling feedback, in accordance with the present disclosure.

FIG. 6C is a diagram illustrating an example associated with interval offsets for feedback communication across a set of CCs that apply bundled feedback across a subset CCs of the set of CCs, in accordance with the present disclosure.

FIG. 6D is a diagram illustrating an example associated with interval offsets for feedback communication across a set of CCs that apply multiplexed feedback or bundled feedback in accordance with downlink time segments, in accordance with the present disclosure.

FIG. 7A is a diagram illustrating example that illustrates downlink scheduling techniques associated with bundled feedback, in accordance with the present disclosure.

FIG. 7B is a diagram illustrating example that illustrates downlink scheduling techniques associated with bundled feedback, in accordance with the present disclosure.

FIG. 8 is a diagram illustrating an example associated with multiplexing and bundling techniques for feedback communications, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Hybrid automatic repeat request (HARQ) combines forward error correction (FEC) and automatic repeat request (ARQ) techniques to more effectively detect and correct transmission errors. In this context, HARQ codebooks enable efficient communication by storing states of transmission blocks requiring acknowledgments. A HARQ codebook may be a structured set of information used in wireless communication systems to manage and schedule acknowledgment (ACK) and negative acknowledgment (NACK) feedback for HARQ processes, thereby facilitating efficient error correction and data retransmission. In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission). In some cases, a UE may support HARQ feedback codebook transmissions. A HARQ feedback codebook transmission may include a feedback message that the UE is to transmit to a network node to provide feedback regarding, for example, downlink data transmissions (for example, transmissions associated with a downlink channel). As used herein, a codebook may be a sequence of bits, which may be constructed using ACK/NACK feedback associated with multiple communications (e.g., multiple downlink communications) that are received by a UE during a feedback window.

HARQ codebooks can be categorized into different types based on functional attributes and applications. One of the categories is a Type-1 HARQ codebook (e.g., configured via a HARQ-ACK-codebook=semi-static information element). A UE may be configured with different types of codebooks, such as the Type-1 HARQ codebook a Type-2 HARQ codebook, or a Type-3 HARQ codebook. For example, the Type-1 HARQ codebook may be associated with a fixed, or static, size (for example, that is configured by a network node). The Type-2 HARQ codebook may be associated with a dynamic size (for example, where the size of the Type-2 HARQ codebook is based at least in part on, or otherwise associated with, scheduling received by the UE). The Type-3 HARQ codebook may be suitable for multi-slot, multi-layer, or data transmissions with a data size that exceeds a threshold, and therefore may be larger and can accommodate aggregated feedback for multiple HARQ processes, spanning across more time slots or frequency resources than Type-1 or Type-2 HARQ codebook. Typically, if the UE is configured to transmit a Type-1 HARQ codebook, then the UE may collect feedback for physical downlink shared channel (PDSCH) communications that are received by the UE during a feedback window (for example, k slots), and the UE may transmit the Type-1 HARQ codebook indicating feedback (for example, ACK/NACK feedback) associated with the PDSCH communications that are received by the UE during the feedback window.

A Type-1 HARQ codebook (e.g., a Type-1 codebook or a Type-1 HARQ codebook) may be a semi-static codebook that has a fixed size. For example, the size of a Type-1 HARQ codebook may be fixed regardless of actual scheduling or resource allocation for the receiver (e.g., for the UE). For example, scheduling information (or configuration information) may indicate a slot offset (sometimes referred to as a K1 value indicated by a PDSCH-to-HARQ_feedback timing indicator field in downlink control information (DCI)) that is indicative of a time interval (e.g., a slot) during which the Type-1 HARQ codebook is to be transmitted. The slot offset may be with respect to the slot of the scheduled PDSCH. The slot offset may be indicative of (e.g., may define) or associated with a feedback window for the Type-1 HARQ codebook. A size of the Type-1 HARQ codebook may be based on the feedback window (e.g., a K1 window). For example, the K1 window may be from the perspective of a of a given uplink interval (e.g., a physical uplink control channel (PUCCH) slot), where the K1 window is a set of downlink intervals (e.g., PDSCH slots) whose feedback can be carried in the uplink interval. The Type-1 HARQ codebook may have a size to accommodate a feedback indication (e.g., HARQ information) for each candidate occasion. The Type-1 HARQ codebook may be configured with a fixed set of slot offsets (K1 values) for scheduling HARQ-ACK feedback. This fixed structure simplifies the management of feedback timing by predefining the possible response windows for received downlink data, ensuring timely and efficient error correction. This fixed K1 window is indicative of the feedback timing slots for ACK/NACK messages following the downlink data reception.

However, such static configuration (e.g., static size) of Type-1 HARQ codebooks can result in signaling inefficiencies. For example, the Type-1 HARQ codebook may have a size that enables feedback to be indicated in each transmission occasion (e.g., slot, symbol, transmission time interval, or another time interval) during a feedback window, where the feedback window is defined, or indicated, by the configured slot offsets (e.g., K1 window) for the Type-1 HARQ codebook. As an example, a UE may receive control information indicating that the UE is to transmit a first Type-1 HARQ codebook in a first time interval (e.g., a first uplink time interval, such as an uplink slot) for a feedback window that includes a set of one or more downlink time intervals. The UE may transmit the first Type-1 HARQ codebook indicating feedback information (e.g., HARQ information, such as ACK or NACK indications for respective downlink time intervals). The UE may receive second control information indicating that the UE is to transmit a second Type-1 HARQ codebook in a second time interval (e.g., a second uplink time interval) that occurs shortly after the first time interval. For example, the second control information may indicate that the UE is to transmit a second Type-1 HARQ codebook in a next available uplink time interval, which may be the second time interval. In such examples, the feedback window for the second Type-1 HARQ codebook may at least partially overlap with the feedback window for the first Type-1 HARQ codebook. In other words, because of the fixed size of the Type-1 HARQ codebooks, each of the first Type-1 HARQ codebook and the second HARQ codebook may include information (e.g., bits) for some of the same downlink time intervals. For example, the second Type-1 HARQ codebook may include fields or bits for indicating feedback associated with one or more downlink time intervals for which the first Type-1 HARQ codebook has already indicated feedback information. In such examples, the UE may include NACK indications (e.g., in the second Type-1 HARQ codebook) for the one or more downlink time intervals for which the first Type-1 HARQ codebook has already indicated feedback information because of the fixed size of the second Type-1 HARQ codebook and because the first Type-1 HARQ codebook has already indicated feedback information for these downlink time intervals. As a result, the transmission of the second Type-1 HARQ codebook may result in inefficient resource utilization by including information (e.g., bits) corresponding to one or more downlink time intervals for which the first Type-1 HARQ codebook has already indicated feedback information.

As described above, the configuration of HARQ ACK feedback timing is often based on preconfigured and static slot offsets, which are typically defined with respect to an uplink frame structure or component carrier (CC) structure via which the HARQ ACK feedback is to be transmitted (e.g., a physical uplink control channel (PUCCH) CC). However, this results in a lack of flexibility for a network node to indicate, or configure, a time at which feedback is to be transmitted for a particular downlink time interval in a downlink frame structure or CC structure. The lack of flexibility may be problematic if dealing with dynamic scheduling requirements, particularly in time division duplex (TDD) configurations. For example, the feedback window for a Type-1 HARQ codebook may be indicated or defined with respect to the uplink frame structure or CC structure, and the network node may be unable to configure or indicate that feedback information for different downlink time intervals (e.g., that would occur during the feedback window) can be transmitted during different uplink time intervals. Additionally, the Type-1 HARQ codebook may be of a fixed size that is based on the number of k slots in the feedback window (e.g., k bits), which may reduce capabilities of the UE to combine feedback information for respective slots that are associated with the same feedback indication (e.g., all associated with ACK or all associated with NACK), which may increase signaling overhead associated with the feedback.

Various aspects relate generally to enhancing slot offset information for feedback transmissions, such as Type-1 HARQ codebook transmissions, and enabling multiplexing and/or bundling techniques for the feedback communications. Some aspects more specifically relate to a network node transmitting, and a UE receiving, configuration information that indicates multiple sets of slot offset information (e.g., multiple K1 windows) for a semi-static HARQ codebook, such as the Type-1 HARQ codebook. For example, the configuration information may schedule a periodic TDD pattern that includes a set of downlink intervals and a set of uplink intervals, where a given K1 window of the multiple K1 windows is associated with one or more downlink intervals of the downlink set and an uplink interval of the set of uplink intervals. That is, each of the multiple K1 windows may be associated with a respective one or more downlink intervals and a respective uplink interval of the periodic TDD pattern. During the one or more downlink intervals associated with the given K1 window, the UE may receive one or more downlink messages and transmit, during the uplink interval associated with the K1 window, a feedback communication associated with the Type-1 HARQ codebook. In some aspects, the configuration information may also indicate whether the feedback communication should include feedback indications associated with respective downlink messages of the one or more downlink messages (e.g., in accordance with multiplexing the feedback) or a single feedback indication associated with the one or more downlink messages (e.g., in accordance with bundling the feedback). In some aspects, the UE may receive the one or more downlink message over multiple CCs. In some aspects, the configuration information may indicate whether to bundle feedback separately per CC, or to bundle feedback across multiple CCs associated with the given K1 window. In some aspects, the UE may divide the given K1 window set into multiple downlink time segments that include respective subsets of the one or more downlink intervals, and bundle feedback separately for the multiple downlink time segments.

Particular aspects of the subject matter described in this disclosure can be implemented to realize one or more of the following potential advantages. In some aspects, the described techniques can be used to provide flexibility for scheduling semi-static HARQ codebook transmissions. This improves the resource utilization efficiency of the semi-static HARQ codebook transmissions. For example, for a semi-static HARQ codebook transmission that is to be transmitted relatively soon after a downlink time interval (or an uplink time interval), control information scheduling the semi-static HARQ codebook transmission may indicate that the semi-static HARQ codebook transmission is to be associated with a K1 window with relatively fewer slot offsets (e.g., as compared to K1 windows configured for the semi-static HARQ codebook). As a result, the semi-static HARQ codebook transmission may have a smaller size (e.g., that is based on the slot offset information indicating relatively fewer slot offsets) while still including feedback information for the downlink time interval (or an uplink time interval). By the network node configuring multiple K1 windows, semi-static HARQ codebook transmissions may be more flexibly configured and/or scheduled (e.g., having different sizes based on the multiple K1 windows), thereby improving the resource utilization efficiency of the semi-static HARQ codebook transmissions. Additionally, enabling the network node and the UE to use flexible semi-static HARQ codebook transmissions reduces signaling overhead that may otherwise be associated with configuring and/or indicating other types of HARQ codebooks, such as a Type-2 HARQ codebook. Additionally, enabling the UE to bundle feedback for a given K1 window may reduce the number of bits included in the semi-static HARQ codebook transmission, which may further reduce signaling overhead.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

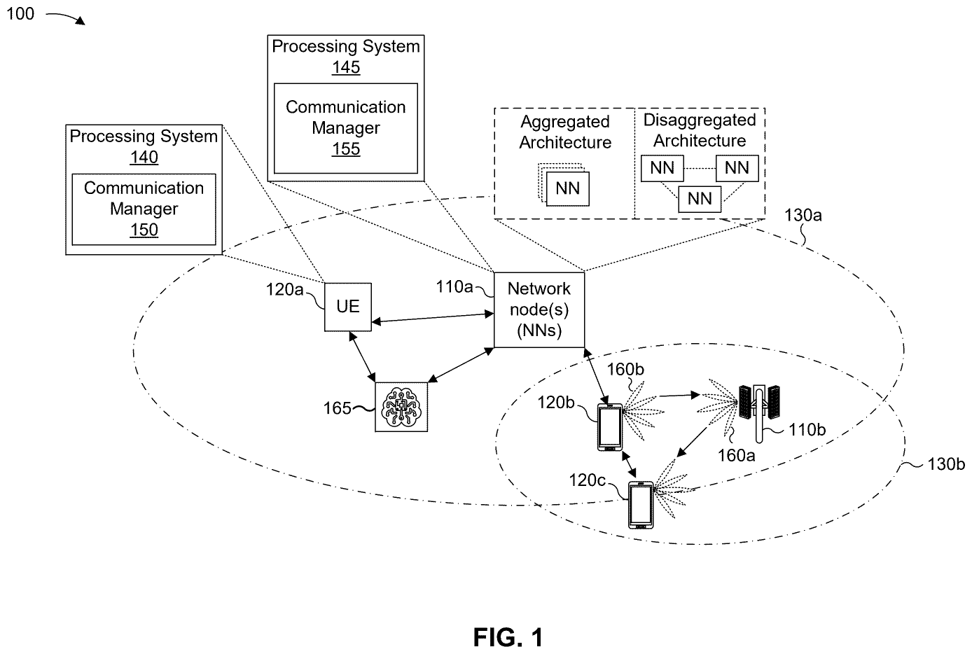

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

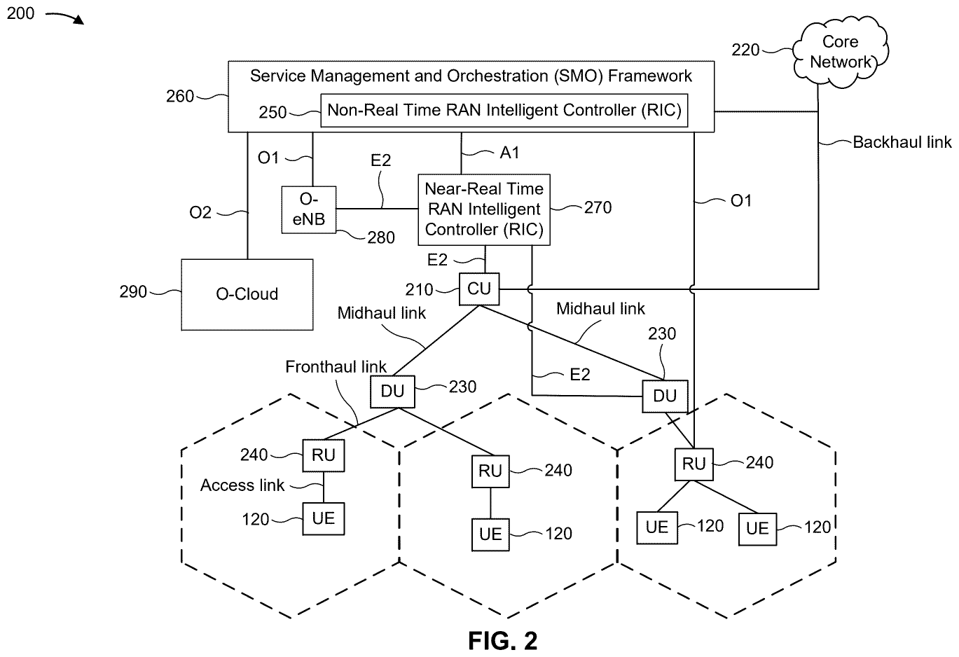

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full CC bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the number of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) number of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; receive, from the network node during the one or more downlink intervals, one or more downlink messages; and transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; transmit, to the UE during the one or more downlink intervals, a one or more downlink messages; and receive, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

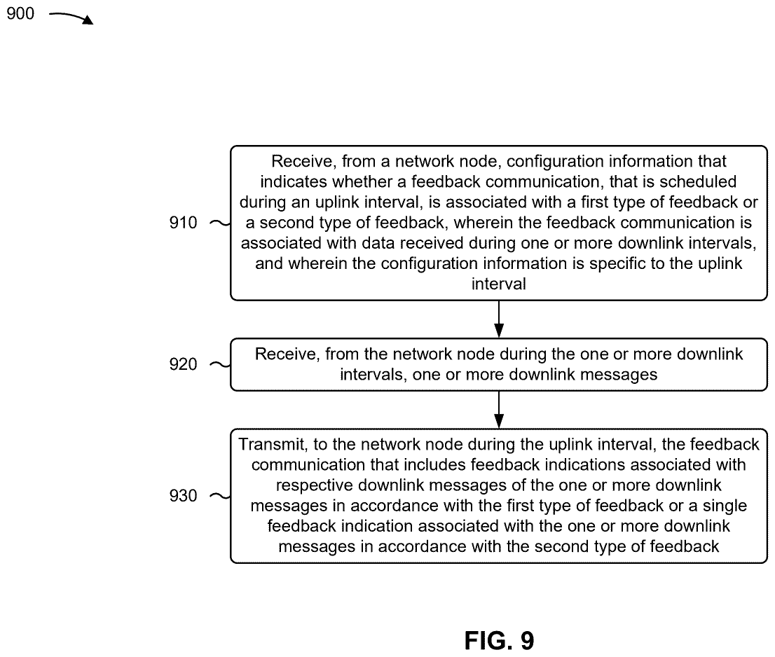

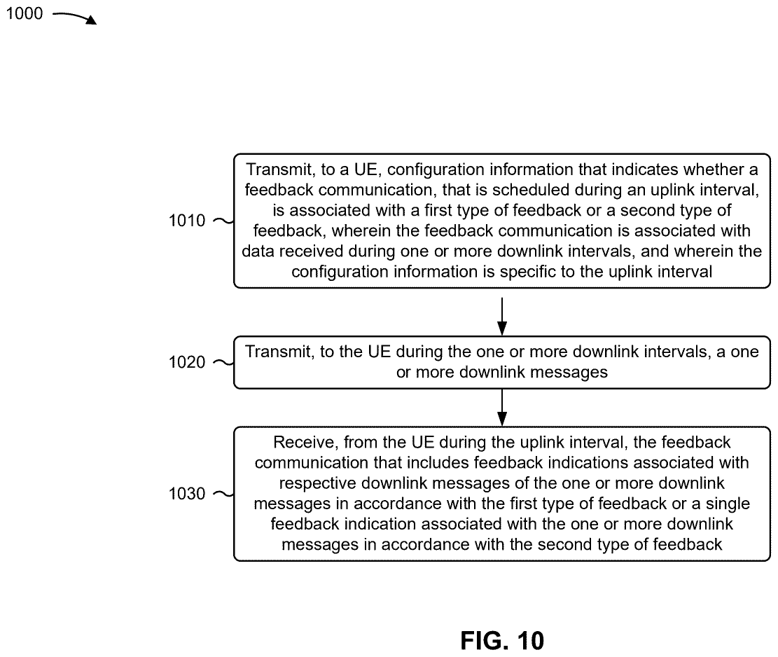

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with multiplexing and bundling techniques for feedback communications, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10 or other processes as described herein. In some examples, executing instructions may include running the instructions, converting the instructions, compiling the instructions, and/or interpreting the instructions, among other examples.

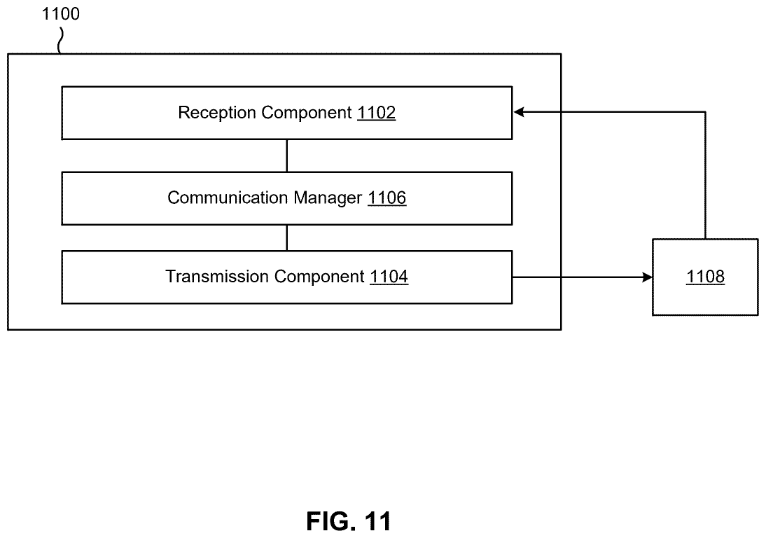

In some aspects, a UE includes means for receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; means for receiving, from the network node during the one or more downlink intervals, one or more downlink messages; and/or means for transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

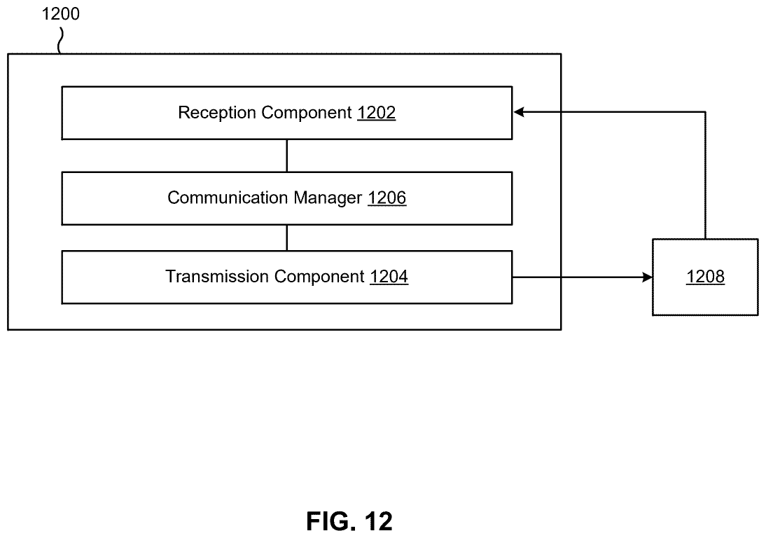

In some aspects, a network node includes means for transmitting, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; means for transmitting, to the UE during the one or more downlink intervals, a one or more downlink messages; and/or means for receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

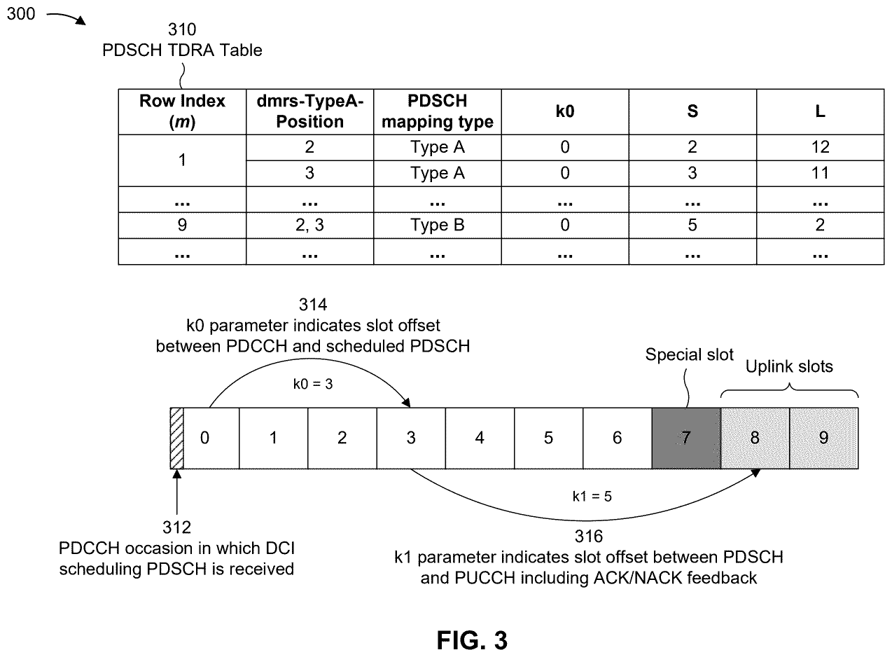

FIG. 3 is a diagram illustrating an example 300 of a time domain resource allocation (TDRA), in accordance with the present disclosure. FIG. 3 shows an example downlink TDRA table 310. The downlink TDRA table 310 may be, for example, a PDSCH TDRA table. In some examples, a network node 110 and the UE 120 may use different TDRA tables than shown in FIG. 3, such as for different configurations, different cells, and/or different sub-carrier spacings of cells.

When scheduling a downlink communication or an uplink communication, a network node 110 may transmit a PDCCH transmission carrying DCI that indicates a TDRA for the downlink or uplink communication. For example, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The network node 110 and the UE 120 may use the TDRA parameters in the corresponding row index for the downlink or uplink communication scheduled via the DCI. In the example shown in FIG. 3, a TDRA index value of m in the DCI may correspond to a row index of m+1 in the TDRA table. For example, a TDRA index value of 0 may correspond to a row index of 1.

As shown in FIG. 3, for a downlink communication (e.g., a PDSCH communication), the TDRA parameters may include, for example, a K₀ value, an S value, and an L value. The K₀ value may represent a timing offset (e.g., in number of slots) between a slot containing the scheduling DCI (carrying a grant that schedules the PDSCH communication) and a slot containing the scheduled PDSCH communication (scheduled via the scheduling DCI). For example, as shown in FIG. 3, and by reference number 312, the UE 120 may receive DCI scheduling a PDSCH in a PDCCH monitoring occasion of slot number 0, and a value of the K₀ parameter may indicate the slot in which the UE 120 can expect to receive the PDSCH transmission scheduled via the DCI. For example, as shown by reference number 314, the UE 120 may expect to receive the PDSCH transmission in slot number 3 based on receiving the scheduling DCI in slot number 0 with the K₀ parameter indicating a timing offset of three slots. The S value may represent a starting symbol for the PDSCH transmission in the indicated slot. The L value may represent a length (e.g., a number of consecutive symbols) of the PDSCH transmission (e.g., in the indicated slot). In some examples, the S value and the L value may collectively be referred to as a start and length indicator value (SLIV). In some examples, the same row index value may correspond to a different set of TDRA parameters depending on a Type A DMRS position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used).

Furthermore, in some examples, a k₁ parameter may be used to indicate a timing offset between the PDSCH transmission scheduled via the DCI and a slot in which the UE 120 is to transmit a PUCCH transmission that carries feedback information (e.g., ACK/NACK feedback for the PDSCH transmission), such as a HARQ codebook transmission. For example, as shown by reference number 316, the UE 120 may be expected to receive a PDSCH transmission in slot number 3 based on the value of the k₀ parameter, and may transmit a PUCCH transmission that carries a HARQ codebook for the PDSCH transmission in slot number 8 based on the k₁ parameter indicating a timing offset of five slots from the slot in which the PDSCH transmission is scheduled (e.g., slot number 3 in the illustrated example). In examples where a PDCCH transmission contains a multi-PDSCH grant, the k₁ parameter may be counted from the slot in which the last granted PDSCH transmission is scheduled. If the numerology of a downlink carrier and an uplink carrier are different (e.g., if an SCS of a PDSCH carrier and a PUCCH carrier are different), then the k₁ parameter may be counted with respect to the numerology of the uplink carrier. In such examples, the reference slot (e.g., from which the k₁ parameter may be counted) may be the last uplink slot that overlaps with the downlinks lot in which the PDSCH transmission (or PDCCH transmission) carrying the information scheduling the feedback transmission is received.

Accordingly, various timing offsets may be used in a wireless network to indicate a timing offset between a PDCCH transmission, a PDSCH transmission, a PUCCH, and/or a PUSCH transmission. For example, as described above, a k₀ parameter may indicate a timing offset (or slot offset) between a slot in which a PDCCH transmission is received and a slot in which a PDSCH transmission granted by the PDCCH transmission is scheduled, a k₁ parameter may indicate a timing offset between the slot in which the PDSCH transmission is scheduled and a slot in which a UE is to transmit ACK/NACK feedback for the PDSCH transmission, and/or a k₂ parameter may indicate a timing offset between a slot in which a PDCCH transmission is received and a slot in which a PUSCH transmission granted by the PDCCH transmission is scheduled. In general, the k₀ and/or k₂ parameters may be determined based on a TDRA field in the scheduling DCI. For example, the TDRA field may have a value that indicates a row index in an RRC-configured TDRA table, and the indicated row index may include a value for the k₀ and/or k₂ parameter (e.g., depending on whether the DCI schedules a PDSCH and/or a PUSCH). Additionally, the k₁ value may be determined and/or based on a timing indicator field of the RRC configuration (e.g., PDSCH-to-HARQ_feedback timing indicator) However, in some cases, the UE 120 may receive a PDCCH transmission that schedules a PDSCH transmission and/or a PUSCH transmission before receiving an RRC configuration. In such examples, the UE 120 may determine the value(s) of the k₀, k₁, and/or k₂ parameters from a default set of values indicated in a default TDRA table. In some examples, when a DCI format other than DCI format 1_0 schedules a PDSCH transmission or a semi-persistent scheduling (SPS) release, the k₁ parameter may be determined by a PDSCH-to-HARQ feedback timing indicator field in the scheduling DCI, which may map to a value for the k₁ parameter that is provided by a configured parameter (e.g., dl-DataToUL-ACK, or dl-DataToUL-ACKForDCIFormat1_2 for DCI format 1_2) that can have a value in a range from zero to fifteen, among other examples. Furthermore, in the PUSCH default TDRA table, the k₂ parameter may have a value of j, j+1, j+2, or j+3, where j is one for a subcarrier spacing of 15 kilohertz (kHz), one for a subcarrier spacing of 30 kHz, two for a subcarrier spacing of 60 kHz, or three for a subcarrier spacing of 120 kHz.

In some examples, a HARQ codebook may be used to provide ACK/NACK feedback corresponding to multiple downlink slots (e.g., multiple PDSCHs), and thus the HARQ codebook may be based at least in part on multiple k₁ values, each associated with a corresponding downlink slot.

In some cases, the UE 120 may support HARQ feedback codebook transmissions (for example, at least for multicast services with a quality of service (QoS) requirement). A HARQ feedback codebook transmission may include a feedback message that the UE 120 is to transmit to the network node 110 to provide feedback regarding, for example, downlink data transmission (for example, transmissions associated with a PDSCH). For example, the UE 120 may be configured to transmit HARQ codebook transmissions (for example, corresponding to one or more HARQ process identifiers).

The UE 120 may be configured with different types of codebooks, such as a Type-1 HARQ codebook, a Type-2 HARQ codebook, or a Type-3 HARQ codebook, among other examples. The Type-1 HARQ codebook may be referred to herein as a “semi-static HARQ feedback codebook.” The Type-2 HARQ codebook may be referred to as a “dynamic HARQ feedback codebook.” For example, the Type-1 HARQ codebook may be associated with a fixed, or static, size (for example, that is configured by the network node 110, such as via slot offset information or a K1 window). The slot offset information (e.g., the K1 window from which a K₁ value may be indicated for a particular grant) may be indicated by an RRC parameter, such as the dl-DataToUL-ACK parameter, or the dl-DataToUL-ACKForDCIFormat1_2 parameter. The Type-2 HARQ codebook may be associated with a dynamic size (for example, where the size of the Type-2 HARQ codebook is based at least in part on, or otherwise associated with, scheduling received by the UE 120). Additional details regarding some HARQ codebooks can be found in, for example, 3GPP Technical Specification (TS) 38.213, Release (Rel.) 18, Version 18.4.0, such as in Section 9.1. Another type of HARQ codebook that the UE 120 may support is an enhanced Type-3 HARQ codebook, which may have a smaller size relative to other HARQ codebooks.

A codebook may be a sequence of bits, which may be constructed using ACK/NACK feedback associated with multiple PDSCH communications that are received by the UE 120 during a feedback window. For Type-1 HARQ codebooks, typically, if the UE 120 is configured to transmit a Type-1 HARQ codebook, the UE 120 may collect feedback for PDSCH communications that are received by the UE 120 during a feedback window (for example, k slots), and may transmit the Type-1 HARQ codebook indicating the feedback information (for example, ACK/NACK feedback) associated with the PDSCH communications that are received by the UE 120 during the feedback window. As described above, the Type-1 HARQ codebook may have a static or fixed size. Therefore, in some cases, if a small number of PDSCH communications are received during the feedback window, transmitting the Type-1 HARQ codebook may consume significant resources (for example, time resources or frequency resources) because the Type-1 HARQ codebook has a fixed sized regardless of the number of PDSCH communications that are received by the UE 120 during the feedback window. For example, a total size of a Type-1 HARQ codebook may be equal to the sum of downlink transmission occasions (e.g., PDSCH occasions) for a given time window, where the time window is defined or indicated by the configured slot offset information (e.g., the configured K1 window). The sum of downlink transmission occasions may account for multiple PDSCH transmissions in a single slot, multiple PDSCH transmissions across multiple slots, multiple PDSCH transmissions across CCs, multiple TBs for a specific PDSCH transmission, and/or multiple code block groups (CBGs) for each TB.

As indicated above, FIG. 3 is provided as an example. Other examples may differ from what is described with regard to FIG. 3.

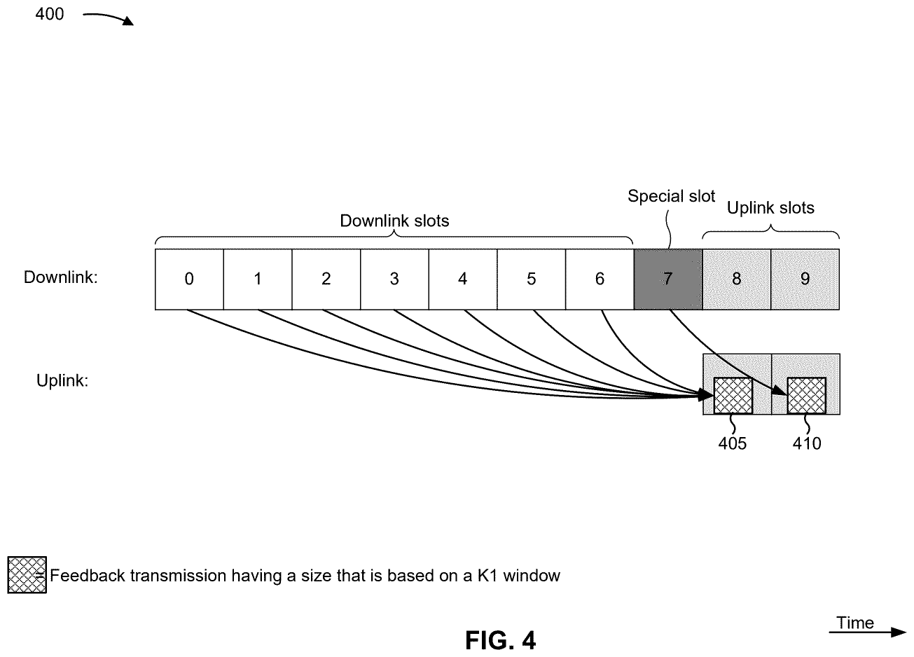

FIG. 4 is a diagram illustrating an example 400 of HARQ codebook transmissions, in accordance with the present disclosure.

As described elsewhere herein, slot offset information may be configured for semi-static HARQ codebook transmissions. For example, for Type-1 HARQ codebook transmissions, a network node 110 may configure slot offset information (e.g., a K1 window) that indicates one or more slot offsets (e.g., one or more values of the k₁ parameter as described in connection with FIG. 3) that can be indicated by control information (e.g., DCI) scheduling a Type-1 HARQ codebook transmission. The slot offset information may be indicative of a set of candidate downlink (e.g., PDSCH) reception occasions. The set of candidate downlink reception occasions may be determined by the UE 120 for each configured downlink serving cell (e.g., each configured downlink CC). For example, if only a DCI 1_0 format is configured for the UE 120, then the slot offset information may indicate slot offsets of {1, 2, 3, 4, 5, 6, 7, 8}. In such examples, each Type-1 HARQ codebook transmission may include fields (e.g., bits) for indicating feedback information (e.g., an ACK indication or a NACK indication) for each candidate downlink reception occasion within a feedback window defined by the slot offset information. In other examples, an RRC parameter (e.g., the dl-DataToUL-ACK parameter or the dl-DataToUL-ACKForDCIFormat1_2 parameter) may configure or indicate the slot offset information, such as when a DCI 1_1 format or a DCI 1_2 format is configured for the serving cell. The Type-1 HARQ codebook transmission may be generated or formed to include as many bits as needed to accommodate (e.g., indicate) feedback information for each potential downlink reception (e.g., from the candidate downlink reception occasions).

For example, downlink reception occasions that overlap with uplink time intervals may not be counted as a potential downlink reception. The remaining candidate downlink reception occasions may be considered potential downlink receptions and the UE 120 may generate the Type-1 HARQ codebook having a size that enables the UE 120 to indicate feedback information for each of the potential downlink receptions. As a result, the size of the Type-1 HARQ codebook may be a function of the slot offset information (e.g., the K1 window) which defines the set of candidate downlink reception occasions, where the potential downlink receptions include the candidate downlink reception occasions with any candidate downlink reception occasions that overlap with uplink time intervals removed.

As shown in FIG. 4, a frame structure or slot structure (e.g., for a downlink carrier) may include one or more downlink slots, one or more special slots, and/or one or more uplink slots. A downlink slot may be a slot configured for downlink transmissions, an uplink slot may be a slot configured for uplink transmissions, and a special slot may be dynamically indicated or configured for either downlink transmissions or uplink transmissions. In the example 400, the special slot (slot 7) shown in FIG. 4 may be used for downlink transmissions.

Although some aspects are described herein using a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, a slot described herein may be a frame, a subframe, a slot, a mini-slot (e.g., one or more symbols), a symbol (e.g., an OFDM symbol), a TTI, and/or a scheduling unit, in other examples.

For example, as shown in FIG. 4, two semi-static HARQ codebook transmissions may be scheduled or transmitted, shown as a feedback transmission 405 and a feedback transmission 410. Because both the feedback transmission 405 and the feedback transmission 410 are associated with the same type of codebook (e.g., the Type-1 HARQ codebook), both the feedback transmission 405 and the feedback transmission 410 are associated with the same slot offset information (e.g., the same K1 window). In some examples, control information (e.g., DCI) may indicate that the feedback transmission 405 is to be transmitted during the uplink slot 8 shown in FIG. 4, such as via a K₁ parameter indicated by the control information. The feedback transmission 405 may include a Type-1 HARQ codebook having a size that is based on the slot offset information (e.g., the K1 window). For example, if the K1 window is {8, 7, 6, 5, 4, 3, 2}, then the feedback transmission 405 may include seven bits, such as for the downlink slots 0 through 6 shown in FIG. 4.

As shown in FIG. 4, control information (e.g., DCI) may indicate that the feedback transmission 410 is to be transmitted during the uplink slot 9. For example, DCI scheduling a downlink transmission during the special slot 7 may indicate that semi-static HARQ feedback is to be provided for the downlink transmission in a next available uplink slot, which may be the uplink slot 9. Because the feedback transmission 410 is associated with a semi-static HARQ codebook, the UE 120 may generate the feedback transmission 410 to have a size that is based on the slot offset information (e.g., the K1 window). For example, similar to the feedback transmission 405, the feedback transmission 410 may include seven bits (e.g., if the K1 window is {8, 7, 6, 5, 4, 3, 2}) corresponding to the downlink slots 1 through 6 and the special slot 7. However, because the feedback transmission 405 already indicated the feedback from the downlink slots 1 through 6, the UE 120 may insert NACK indications for bits in the feedback transmission 410 corresponding to the downlink slots 1 through 6 (e.g., as placeholders or as a means to fill in the bits generated for the Type-1 HARQ codebook). For example, the only feedback information that a network node 110 may obtain from the feedback transmission 410 may be for the special slot 7. However, the feedback transmission 410 may still include the seven bits as defined by the slot offset information (e.g., the K1 window) configured for Type-1 HARQ codebooks.

This problem may be exacerbated when multiple CCs are configured for the UE 120 (e.g., increasing the number of potential downlink receptions) and/or where a downlink carrier is configured with a different numerology than the uplink carrier. For example, if an SCS for the downlink carrier is greater than the SCS for the uplink carrier, this may result in more candidate downlink occasions being included in the feedback window indicated by the slot offset information because the slot offsets are counted with respective to the SCS of the uplink carrier. When the SCS for the uplink carrier is smaller (e.g., 30 kHz vs. 120 kHz for the downlink carrier), a slot in the uplink carrier may have a relatively longer duration than a slot in the downlink carrier, resulting in multiple downlink slots being included in the duration of a single uplink slot in the uplink carrier. This may increase the number of potential downlink receptions as indicated by the slot offset information, further increasing the size of the Type-1 HARQ ACK feedback transmission and further degrading the resource utilization efficiency.

As indicated above, FIG. 4 is provided as an example. Other examples may differ from what is described with regard to FIG. 4.

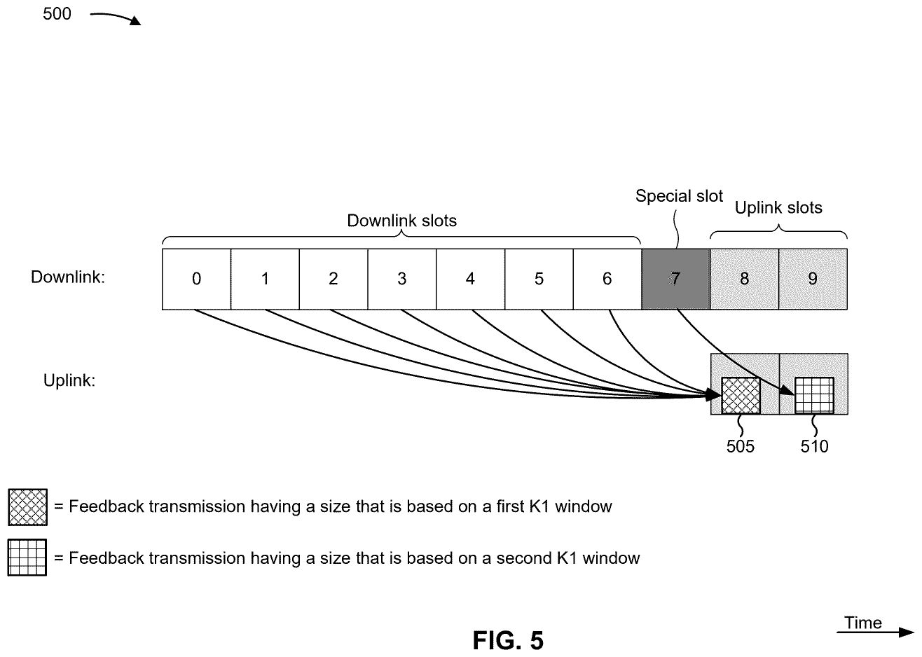

FIG. 5 is a diagram of an example 500 of slot offsets for feedback transmission with respect to an uplink carrier, in accordance with the present disclosure. Example 500 shows a TDD pattern that includes one or more downlink slots, one or more special (or flexible) slots and one or more uplink slots.

As described elsewhere herein, multiple sets of slot offset information may be configured for semi-static HARQ codebooks (e.g., Type-1 HARQ codebooks). For example, a first set of slot offset information may include slot offsets of {8, 7, 6, 5, 4, 3, 2} and a second set of slot offset information may include a slot offset of {2}. The first slot offset information may be the first K1 window described in FIG. 5, and the second slot offset information may be the second K1 window described in FIG. 5. In some aspects, the configuration information may indicate a pattern such that the uplink slot 8 shown in FIG. 5 is associated with the first slot offset information and the uplink slot 9 is associated with the second slot offset information.

As shown in FIG. 5, a feedback window for a Type-1 HARQ codebook to be transmitting during the uplink slot 8 may be based on the first set of slot offset information (e.g., the first K1 window) including slot offsets of {8, 7, 6, 5, 4, 3, 2}. For example, as shown in FIG. 5, the downlink slots 0 through 6 may be mapped to the uplink slot 8 for feedback transmission. As a result, a feedback transmission 505 (e.g., the Type-1 HARQ codebook) transmitted during the uplink slot 8 may have a size configured to indicate feedback for each possible downlink reception candidate that occurs during the downlink slots 0 through 6. A feedback window for a Type-1 HARQ codebook to be transmitting during the uplink slot 9 may be based on the second set of slot offset information (e.g., the second K1 window) including a slot offset of {2}. For example, as shown in FIG. 5, the special slot 7 may be mapped to the uplink slot 9 for feedback transmission. As a result, a feedback transmission 510 (e.g., the Type-1 HARQ codebook) transmitted during the uplink slot 9 may have a size configured to indicate feedback for each possible downlink reception candidate that occurs during the special slot 7. This may enable the feedback transmission 510 (e.g., the Type-1 HARQ codebook) transmitted during the uplink slot 9 to have a relatively smaller size than the feedback transmission 505 (e.g., the Type-1 HARQ codebook) transmitted during the uplink slot 8, thereby improving the resource utilization efficiency.

As indicated above, FIG. 5 is provided as an example. Other examples may differ from what is described with regard to FIG. 5.

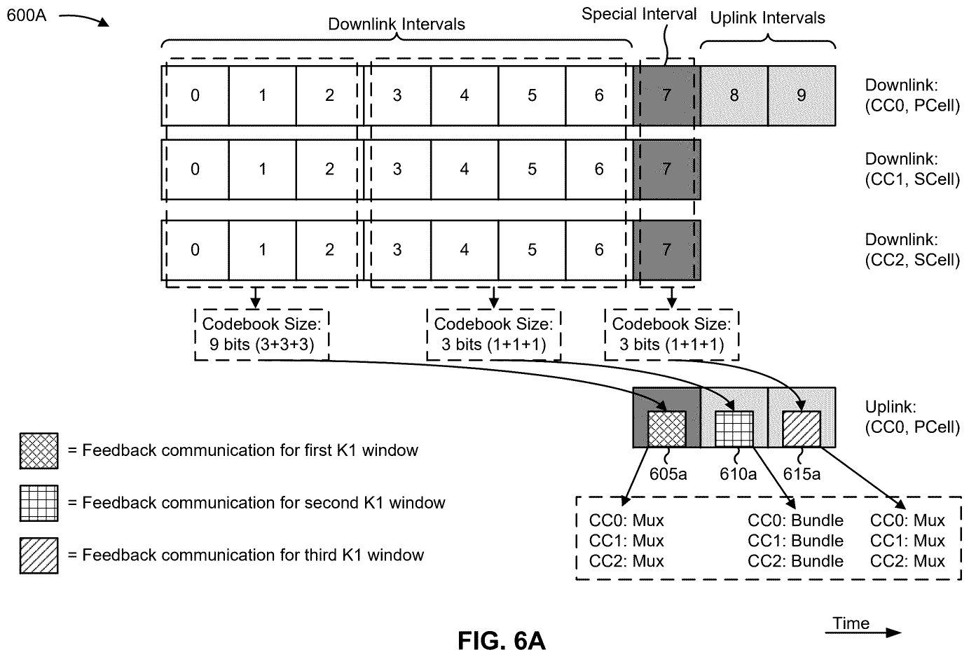

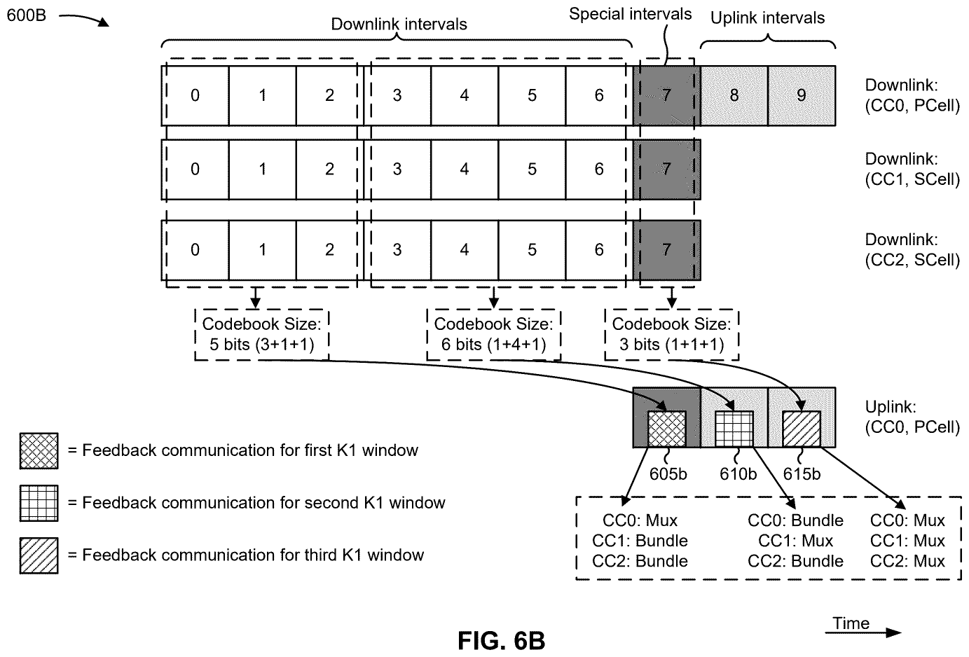

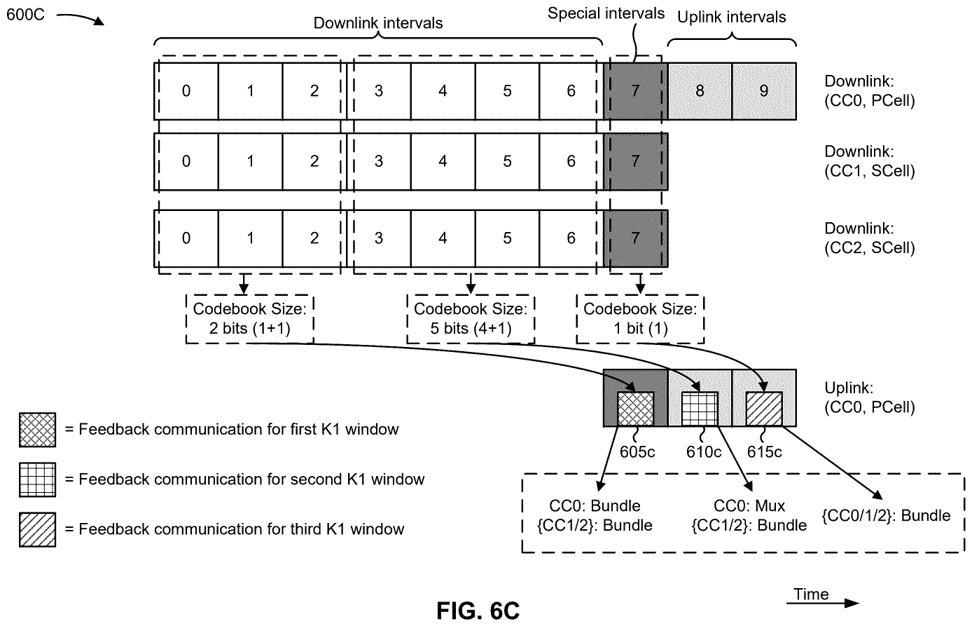

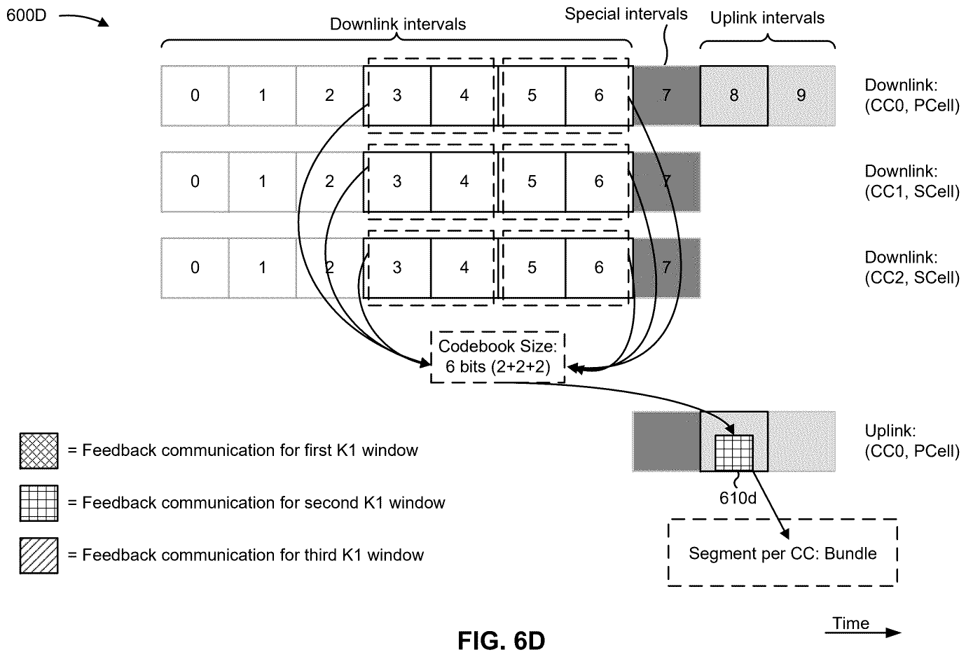

FIGS. 6A-6D are diagrams illustrating examples 600A through 600D that illustrate a TDD pattern, in accordance with the present disclosure. For instance, examples 600A through 600D show a TDD pattern that includes one or more downlink intervals, one or more special (or flexible) intervals, and one or more uplink intervals. In some aspects, the TDD pattern may be associated with a set of CCs. For example, the TDD pattern may be associated with a CC0, a CC1, and a CC2. Additionally, while the TDD pattern of examples 6A through 6D is associated with a set of 3 CCs (e.g., CC0, CC1, and CC2), the TDD pattern may be associated with any number of CCs.

In some aspects of FIGS. 6A through 6D, the TDD pattern may be associated with a UE (e.g., a UE 120) transmitting feedback communications associated with downlink messages received during the downlink intervals. For example, the uplink resources of special interval 7 may be configured for the UE 120 to transmit a feedback communication 605, where the feedback communication 605 is associated with downlink messages received during downlink slots 0 through 2. Additionally, or alternatively, uplink interval 8 may be configured for the UE 120 to transmit a feedback communication 610, where the feedback communication 610 is associated with downlink messages received during downlink intervals 3 through 6. Additionally, or alternatively, uplink interval 9 may be configured for the UE 120 to transmit a feedback communication 615, where the feedback communication 615 is associated with downlink messages received via downlink resources special interval 7.

As described elsewhere herein, multiple sets of interval offset information may be configured for semi-static HARQ codebooks (e.g., Type-1 HARQ codebooks). For example, a first interval offset information may include interval offsets of {7, 6, 5}, a second interval offset Information may include interval offsets of {5, 4, 3, 2}, and a third interval offset information may include an interval offset of {2}. In some aspects, configuration information may indicate a pattern such that the special interval 7 is associated with the first interval offset information, the uplink interval 8 is associated with the second interval offset information, and the uplink interval 9 is associated with the third interval offset information shown in FIGS. 6A through 6D.

As shown in FIGS. 6A through 6D, the first K1 window for a Type-1 HARQ codebook to be transmitted during the special interval 7 may be based on the first interval offset information (e.g., the first K1 window) including interval offsets of {7, 6, 5}. For example, as shown in FIGS. 6A through 6D, the downlink intervals 0 through 2 may be mapped to the uplink interval 7 for feedback communication. As a result, a feedback communication 605 (e.g., the Type-1 HARQ codebook) transmitted during the special interval 7 may have a size configured to indicate feedback for each possible downlink reception candidate that occurs during the downlink intervals 0 through 2. The second K1 window for a Type-1 HARQ codebook to be transmitted during the uplink interval 8 may be based on the second interval offset information (e.g., the second K1 window) including interval offsets of {5, 4, 3, 2}. For example, as shown in FIGS. 6A through 6D, the downlink intervals 3 through 6 may be mapped to the uplink interval 8 for feedback communication. As a result, a feedback communication 610 (e.g., the Type-1 HARQ codebook) transmitted during the uplink interval 8 may have a size configured to indicate feedback for each possible downlink reception candidate that occurs during downlink intervals 3 through 6. A third K1 window for a Type-1 HARQ codebook to be transmitted during the uplink interval 9 may be based on the third interval offset information (e.g., the third K1 window) including an interval offset of {2}. For example, as shown in FIGS. 6A through 6D, the special interval 7 may be mapped to the uplink interval 9 for feedback communication. As a result, a feedback communication 615 (e.g., the Type-1 HARQ codebook) transmitted during the uplink interval 9 may have a size configured to indicate feedback for each possible downlink reception candidate that occurs during special interval 7. This may enable the feedback communication 605, the feedback communication 610, and the feedback communication 615 to be associated with respective numbers of downlink intervals, thereby improving resource utilization efficiency.

In some aspects, the network node 110 may transmit, and the UE 120 may receive, configuration information that configures one or more aspects of the TDD pattern. For example, the configuration information may be part of an RRC configuration message transmitted via RRC signaling. In alternative examples, the network node 110 may transmit, and the UE 120 may receive, the configuration information via another type of signaling, such as via one or more of system information signaling (e.g., a master information block (MIB) and/or a system information block (SIB), among other examples), MAC signaling (e.g., one or more MAC-CEs), and/or DCI, among other examples.

In some aspects, the configuration information may indicate and/or configure the multiple sets of interval offset information (e.g., the first K1 window, the second K1 window, and the K1 window).

In some aspects, the configuration information may indicate a periodicity associated with the TDD pattern. That is, the TDD pattern, illustrated in FIGS. 6A through 6D, may be a periodic TDD pattern that continuously repeats intervals 0 through 9 for a duration of time (e.g., repeated with a period of 10 time intervals). In some aspects, the configuration information may indicate an integer number of repetitions of the TDD pattern. In some aspects, the UE 120 and the network node 110 may operate in accordance with the TDD pattern until the network node 110 transmits, and the UE 120 receives, updated configuration information that modifies or ends the TDD pattern.

In some aspects, the configuration information may configure the set of CCs. For example, CC0 may be a PUCCH CC, which the UE 120 may use to transmit, to the network node 110, control information, such as HARQ-ACKs (e.g., feedback communication 605, feedback communication 610, and feedback communication 615), scheduling requests (SRs), and/or CSI, among other examples. Additionally, the network node 110 may transmit downlink messages, such as downlink control signaling, via the CC0 during downlink intervals and/or flexible intervals. The CC0 may be associated with a primary cell (PCell), which is the primary serving cell for the UE 120 in a carrier aggregation configuration. The CC1 and the CC2 may be respective PDSCH CCs. For example, a PDSCH CC may be a CC used by the network node 110 to transmit, and the UE 120 to receive, downlink messages such as downlink data from the network node 110. In some aspects, CC1 may be associated with a first secondary cell (SCell) in addition to the PCell, and the CC2 may be associated with a second SCell in addition to the PCell. In some other examples, the set of CCs may be configured via signaling separate from the configuration information (e.g., separate RRC signaling, MAC signaling, or DCI signaling).

In some aspects, the configuration information may indicate a type of feedback associated with each uplink interval of the TDD pattern (e.g., the special interval 7, the uplink interval 8, and the uplink interval 9). For instance, the type of feedback may include multiplexed feedback and/or bundled feedback.

If multiplexed feedback is configured for an uplink interval (e.g., PUCCH interval), each valid downlink interval in the K1 window associated with that uplink interval corresponds to a bit location in the Type-1 HARQ codebook. For example, if uplink interval 8 is associated with multiplexed feedback for CC0, then the Type-1 HARQ codebook included in feedback communication 610 may include a respective bit for each of downlink intervals 3 through 6. In accordance with multiplexed feedback, if the UE 120 successfully receives a downlink message during a downlink interval, then the bit associated with the downlink interval is of a first value that indicates an ACK. If, however, there is no downlink message scheduled during a downlink interval or the UE 120 does not successfully receive a downlink message scheduled during the downlink interval, then the bit associated with the downlink interval is of a second value that indicates a NACK. Therefore, the multiplexed feedback may allow for more granular feedback between the downlink messages transmitted during respective downlink intervals, which may increase the efficacy of the Type-1 HARQ codebook included in the feedback communication 605, the feedback communication 610, and the feedback communication 615.

If bundled feedback is configured for an uplink interval (e.g., a PUCCH interval), then the UE 120 may include a single bit in the Type-1 HARQ codebook associated with the uplink interval, where the single bit is associated with the one or more valid downlink intervals in the K1 window associated with the uplink interval. For example, if uplink interval 8 is associated with bundled feedback for CC0, then the Type-1 HARQ codebook included in feedback communication 610 may include a single bit for downlink intervals 3 through 6. In accordance with bundled feedback, if the UE 120 successfully receives a downlink message during each downlink interval associated with the single bit, then the single bit is of a first value that indicates an ACK. If, however, at least one downlink interval associated with the single bit is not scheduled for a downlink message or the UE 120 does not successfully receive a downlink message scheduled during at least one downlink interval associated with the single bit, then the single bit is of a second value that indicates a NACK. Therefore, bundled feedback may reduce the number of bits included in the Type-1 HARQ codebook, which may reduce signaling overhead associated with the feedback communication 605, the feedback communication 610, and the feedback communication 615.

In some aspects, for a given period of the TDD pattern and for different uplink intervals of the PUCCH CC, the configuration information may indicate either multiplexed feedback or bundled feedback. If the PUCCH CC (e.g., CC0) is TDD, the TDD pattern may have a same, or an integer multiple of the, periodicity as the TDD pattern, and the configuration information may indicate multiplexed feedback or bundled feedback for intervals that include uplink symbols or flexible symbols.

In some aspects, the feedback communication 605, 610, and 615 may be associated with feedback for PDSCH transport blocks. For example, the downlink intervals 0 through 6 may be examples of downlink slots, where the network node 110 may schedule one or more PDSCH transport blocks during one or more of the downlink slots. Additionally, the special interval 7 and the uplink intervals 8 and 9 may respectively be a special slot and uplink slots. Therefore, each bit of the Type-1 HARQ codebook may be associated with a respective downlink slot and may be associated with indicating ACK/NACK for PDSCH transport blocks.

In some aspects, the feedback communications 605, 610, and 615 may be associated with feedback for one or more CBGs of a PDSCH transport block. For example, the downlink intervals 0 through 6 may be downlink portions of one or more downlink slots, where the network node 110 may schedule one or more CBGs that are associated with a PDSCH transport block during one or more of the downlink portions. For instance, in one example, downlink intervals 3 through 6 may be a set of four downlink portions that span a downlink slot, and the network node 110 may schedule one or more CBGs during the four downlink portions, where the one or more CBGs are associated with a same PDSCH transport block. Additionally, the special interval 7 and the uplink intervals 8 and 9 may respectively be a special slot and uplink slots. Therefore, each bit of the Type-1 HARQ codebook may be associated with a downlink portion of a slot and may be associated with indicating ACK/NACK for a CBG (e.g., CBG-based feedback). In some aspects, configuring CBG-based feedback may be based on the size of the K1 window associated with the special slot or uplink slot. For example, if a size (e.g., duration) of the K1 window satisfies (e.g., is less than) a threshold, then the CBG-based feedback may be configured for the associated special or uplink slot. If, however, the size (e.g., duration) of the K1 window exceeds (e.g., is greater than) the threshold, then the CBG-based feedback may not be configured for the associated special or uplink slot. Additionally or alternatively, whether CBG-based feedback or TB-based feedback is to be reported, can be configured to the UE by the network for each UL time interval (e.g., for each of the special interval 7 and the uplink intervals 8 and 9, separately) associated with the corresponding configured K1 window.

As described herein, FIGS. 6A through 6D illustrate respective aspects of the implementing multiplexed feedback and/or bundled feedback per K1 window across a set of CCs in accordance with the configuration information.

FIG. 6A is a diagram illustrating an example 600A associated with interval offsets for feedback communication across a set of CCs that each separately apply multiplexed feedback or bundling feedback, in accordance with the present disclosure. That is, the same configuration for multiplexed feedback or bundled feedback is applied for all downlink CCs separately for a given K1 window. Additionally, when the configuration information configures bundled feedback, the bundled feedback is applied in the time domain of each CC (e.g., no bundling across CCs).

In accordance with example 600A, the configuration information may indicate that multiplexed feedback is associated with the first interval offset information. In other words, the configuration information may indicate for the UE 120 to apply multiplexed feedback for the first K1 window, where the multiplexed feedback is applied separately for CC0, CC1, and CC2. For instance, with reference to the CC0, the Type-1 HARQ codebook feedback may include a first bit associated with downlink interval 0, a second bit associated with downlink interval 1, and a third bit associated with downlink interval 2. With reference to CC1, the Type-1 HARQ codebook feedback may include a fourth bit associated with downlink interval 0, a fifth bit associated with downlink interval 1, and a sixth bit associated with downlink interval 2. With reference to CC2, the Type-1 HARQ codebook feedback may include a seventh bit associated with downlink interval 0, an eighth bit associated with downlink interval 1, and a ninth bit associated with downlink interval 2. That is, the codebook size included in a feedback communication 605a that is associated with the first K1 window may be 9 bits (e.g., three respective bits for each of CC0, CC1, and CC2).

Additionally, the configuration information may indicate that bundled feedback is associated with the second interval offset information. In other words, the configuration information may indicate for the UE 120 to apply bundled feedback for the second K1 window, where the bundled feedback is applied separately for CC0, CC1, and CC2. For instance, with reference to the CC0, the Type-1 HARQ codebook feedback may include a first single bit associated with each of downlink intervals 3 through 6. With reference to the CC1, the Type-1 HARQ codebook feedback may include a second single bit associated with each of downlink intervals 3 through 6. With reference to the CC2, the Type-1 HARQ codebook feedback may include a third single bit associated with each of downlink intervals 3 through 6. That is, the codebook size included in a feedback communication 610a that is associated with the second K1 window may be 3 bits (e.g., one respective bit for each of CC0, CC1, and CC2).

Additionally, the configuration information may indicate that multiplexed feedback is associated with the third interval offset information. In other words, the configuration information may indicate for the UE 120 to apply multiplexed feedback for the third K1 window, where the multiplexed feedback is applied separately for CC0, CC1, and CC2. For instance, with reference to the CC0, the Type-1 HARQ codebook feedback may include a first bit associated with special interval 7. With reference to the CC1, the Type-1 HARQ codebook feedback may include a second bit associated with special interval 7. With reference to the CC2, the Type-1 HARQ codebook feedback may include a third bit associated with special interval 7. That is, the codebook size included in a feedback communication 615a that is associated with the third K1 window may be 3 bits (e.g., one respective bit for each of CC0, CC1, and CC2). In some aspects, if a given K1 window spans a single downlink interval, then multiplexed feedback and bundled feedback may result in the same information being included in the associated Type-1 HARQ codebook.

Therefore, in accordance with aspects of example 600A, for each K1 window the configuration information indicates for the set of CCs to each separately apply the multiplexed feedback or to each separately apply the bundled feedback. Such aspects of example 600A may result in one or more advantages. For example, using the same type of feedback for a given K1 window (e.g., all multiplexed feedback or all bundled feedback) may reduce the complexity and the signaling overhead of the configuration information. Additionally, applying the same type of feedback separately per CC for a given K1 window may reduce complexity associated with bundling feedback information across multiple CCs.

FIG. 6B is a diagram illustrating an example 600B associated with interval offsets for feedback communication across a set of CCs that separately apply multiplexed feedback or bundling feedback, in accordance with the present disclosure. That is, for a given K1 window, some CCs may apply multiplexed feedback, and some other CCs may apply bundled feedback. Additionally, when bundling is configured for a CC, the bundling may be associated with a time domain of the CC (e.g., no bundling across CCs).

In accordance with example 600B, the configuration information may indicate that, for the first interval offset information, CC0 is associated with multiplexed feedback, CC1 is associated with bundled feedback, and CC2 is associated with bundled feedback. In other words, the configuration information may indicate, in accordance with the first K1 window, for the UE 120 to apply multiplexed feedback for CC0, bundled feedback for CC1, and bundled feedback for CC2. For instance, with reference to the CC0, the Type-1 HARQ codebook feedback may include a first bit associated with downlink interval 0, a second bit associated with downlink interval 1, and a third bit associated with downlink interval 2. With reference to CC1, the Type-1 HARQ codebook feedback may include a fourth single bit associated with each of downlink intervals 0 through 2. With reference to CC2, the Type-1 HARQ codebook feedback may include a fifth single bit associated with each of downlink intervals 0 through 2. That is, the codebook size included in a feedback communication 605b that is associated with the first K1 window may be 5 bits (e.g., three bits for CC0, a single bit for CC1, and a single bit for CC2).

Additionally, the configuration information may indicate that, for the second interval offset information, CC0 is associated with bundled feedback, CC1 is associated with multiplexed feedback, and CC2 is associated with bundled feedback. In other words, the configuration information may indicate, in accordance with the second K1 window, for the UE 120 to apply bundled feedback for CC0, multiplexed feedback for CC1, and bundled feedback for CC2. For instance, with reference to the CC0, the Type-1 HARQ codebook feedback may include a first single bit associated with each of downlink intervals 3 through 6. With reference to the CC1, the Type-1 HARQ codebook feedback may include a second bit associated with downlink interval 3, a third bit associated with downlink interval 4, a fourth bit associated with downlink interval 5, and a fifth bit associated with downlink interval 6. With reference to the CC2, the Type-1 HARQ codebook feedback may include a sixth single bit associated with each of downlink intervals 3 through 6. That is, the codebook size included in a feedback communication 610b that is associated with the second K1 window may be 6 bits (e.g., a single bit for CC0, four bits for CC1, and a single bit for CC2).

Additionally, the configuration information may indicate that, for the third interval offset information, CC0 is associated with multiplexed feedback, CC1 is associated with multiplexed feedback, and CC2 is associated with multiplexed feedback. In other words, the configuration information may indicate, in accordance with the third K1 window, for the UE 120 to apply multiplexed feedback for CC0, multiplexed feedback for CC1, and multiplexed feedback for CC2. For instance, with reference to the CC0, the Type-1 HARQ codebook feedback may include a first bit associated with each of special interval 7. With reference to the CC1, the Type-1 HARQ codebook feedback may include a second bit associated with special interval 7. With reference to the CC2, the Type-1 HARQ codebook feedback may include a third bit associated with special interval 7. That is, the codebook size included in a feedback communication 615b that is associated with the third K1 window may be 3 bits (e.g., one bit for CC0, one bit for CC1, and one bit for CC2). In some aspects, if a given K1 window spans a single downlink interval, then multiplexed feedback and bundled feedback may result in the same information included in the associated Type-1 HARQ codebook.

Therefore, in accordance with aspects of example 600b, for each K1 window, the configuration information separately indicates for each CC of the set of CCs whether to apply the multiplexed feedback or the bundled feedback. Such aspects of example 600B may result in one or more advantages. For example, using different feedback types across different CCs of a given K1 window may increase flexibility for the associated feedback communication. Additionally, applying a respective type of feedback separately per CC for a given K1 window may reduce complexity associated with bundling feedback information across multiple CCs.

FIG. 6C is a diagram illustrating an example 600C associated with interval offsets for feedback communication across a set of CCs that apply bundled feedback across a subset CCs of the set of CCs, in accordance with the present disclosure. That is, for a given K1 window, some CCs may apply multiplexed feedback, some CCs may apply bundled feedback, and/or a subset of CCs may combine bundled feedback. Additionally, if bundled feedback is configured across time and across all CCs of the set of CCs for a given K1 window, then a single bit is included in the associated feedback communication.

In accordance with example 600C, the configuration information may indicate that, for the first interval offset information, CC0 is associated with bundled feedback and CC1/CC2 are associated with bundled feedback. In other words, the configuration information may indicate, in accordance with the first K1 window, for the UE 120 to apply bundled feedback for CC0 and bundled feedback jointly for CC1 and CC2. For instance, with reference to the CC0, the Type-1 HARQ codebook feedback may include a first single bit associated with downlink interval 0 through downlink interval 2. With reference to CC1 and CC2, the Type-1 HARQ codebook feedback may include a second single bit associated with each of downlink interval 0 through downlink interval 2 for CC1 and downlink interval 0 through downlink interval 2 for CC2. That is, the codebook size included in a feedback communication 605c that is associated with the first K1 window may be 2 bits (e.g., a single bit for CC0, a single bit for CC1/CC2).

Additionally, the configuration information may indicate that, for the second interval offset information, CC0 is associated with multiplexed feedback and CC1/CC2 are associated with bundled feedback. In other words, the configuration information may indicate, in accordance with the second K1 window, for the UE 120 to apply multiplexed feedback for CC0 and bundled feedback jointly for CC1 and CC2. For instance, with reference to the CC0, the Type-1 HARQ codebook feedback may include a first bit for downlink interval 3, a second bit for downlink interval 4, a third bit for downlink interval 5, and fourth bit for downlink interval 6. With reference to CC1 and CC2, the Type-1 HARQ codebook feedback may include a fifth single bit associated with each of downlink interval 3 through downlink interval 6 for CC1 and downlink interval 3 through downlink interval 6 for CC2. That is, the codebook size included in a feedback communication 610c that is associated with the second K1 window may be 5 bits (e.g., four bits for CC0 and a single bit for CC1/CC2).

Additionally, the configuration information may indicate that, for the third interval offset information, CC0, CC1, and CC2 are associated with a same bundled feedback. In other words, the configuration information may indicate, in accordance with the third K1 window, for the UE 120 to apply single bundled feedback for CC0/CC1/CC2. For instance, the Type-1 HARQ codebook feedback may include a single bit associated with each of special interval 7 for CC0, special interval 7 for CC1, and special interval 7 for CC2. That is, the codebook size included in a feedback communication 615c that is associated with the third K1 window may be 1 bit (e.g., one bit for CC0/CC1/CC2).

Therefore, in accordance with aspects of example 600C, for each K1 window the configuration information indicates one or more subsets of CCs from the set of CCs and separately indicates, for each subset of CCs of the one or more subsets of CCs, whether to apply the multiplexed feedback or the bundled feedback. Such aspects of example 600C may result in one or more advantages. For example, combining bundled feedback across multiple CCs may reduce signaling overhead associated with the feedback communications.

FIG. 6D is a diagram illustrating an example 600D associated with interval offsets for feedback communication across a set of CCs that apply multiplexed feedback or bundled feedback in accordance with downlink time segments, in accordance with the present disclosure. That is, for feedback for a given uplink or PUCCH interval, the associated K1 window can be divided into multiple downlink time segments. Therefore, the UE 120 may apply bundled feedback per downlink time segment of a K1 window (e.g., as opposed to per a whole K1 window). In accordance with downlink time segments being associated with a given K1 window, the configuration of downlink time segments may also be uplink or PUCCH interval dependent (e.g., can be configured differently for different uplink or PUCCH intervals). In other words, the first K1 window, the second K1 window, and the third K1 window may be associated with different downlink time segment configurations. In some aspects, the configuration information configures the downlink time segments per K1 window. In some other examples, the UE 120 configures the downlink time segments per K1 window.

As, illustrated in example 600D, the second K1 window (e.g., associated with the second interval offset information) may include multiple downlink time segments in the time domain and in the frequency domain (e.g., per CC). For example, in accordance with CC0 of the second K1 window, downlink intervals 3 and 4 may be associated with a first downlink time segment and downlink intervals 5 and 6 may be associated with a second downlink time segment. In accordance with CC1 of the second K1 window, downlink intervals 3 and 4 may be associated with a third downlink time segment and downlink intervals 5 and 6 may be associated with a fourth downlink time segment. In accordance with CC2 of the second K1 window, downlink intervals 3 and 4 may be associated with a fifth downlink time segment and downlink intervals 5 and 6 may be associated with a sixth downlink time segment. Therefore, the UE 120 may apply separate bundled feedback for each of the first through sixth downlink time segments of the second K1 window. That is, the codebook size included in a feedback communication 610d that is associated with the second K1 window may be 6 bits (e.g., two bits for CC0 associated with the first and second downlink time segment, two bits for CC1 associated with the third and fourth downlink time segment, and two bits for CC2 associated with the fifth and sixth downlink time segment).

In some aspects, the configuration of downlink time segments may be further configured per CC. That is, for a given uplink or PUCCH interval, CC1 may be associated with a different downlink time segment configuration compared to CC2. For instance, in one example of the second K1 window, CC1 may be associated with a first downlink time segment that spans downlink intervals 3 and 4 and a second downlink time segment that spans downlink intervals 5 and 6, while CC2 may be associated with a third downlink time segment that spans downlink intervals 3 through 5 and a fourth downlink time segment that spans downlink interval 6.

In some aspects, the configuration of downlink time segments may be defined in the time domain (e.g., a subset of downlink intervals of a given K1 window). Additionally, or alternatively, the configuration of downlink time segments may be defined in the frequency domain (e.g., a subset of CCs of a given K1 window). For instance, in one example, a given downlink time segment may be associated with one or more of CC0, CC1, and CC2. Additionally, or alternatively, the configuration of downlink time segments may be defined in the spatial domain (e.g., a subset of codewords of a given K1 window). For instance, the spatial domain may be associated with how antenna arrays at the UE 120 and/or the network node 110 are utilized to shape beams for transmitting and/or receiving data. Associating a spatial domain with a set of codewords means that the UE and/or the network node 110 may transmit specific codewords using particular beamforming or spatial configurations. Therefore, if a given K1 window is associated with a set of codewords, then a downlink time segment of the given K1 window may be associated with a subset of the set of codewords.

In some aspects, one or more downlink time segments may be configured for multiplexed feedback while one or more other downlink time segments may be configured for bundled feedback. For instance, in one example, if a given K1 window is associated with a set of downlink time segments (such as the first through sixth downlink time segments of the second K1 window in example 600D), then a first subset of the set of downlink time segments may be configured for multiplexed feedback while a second subset of the set of downlink time segments may be configured for bundled feedback.

Additionally, while example 600D illustrates the second K1 window including multiple downlink time segments, the first K1 window and the third K1 window may or may not include multiple respective downlink time segments that are independent of the downlink time segments of the second K1 window.

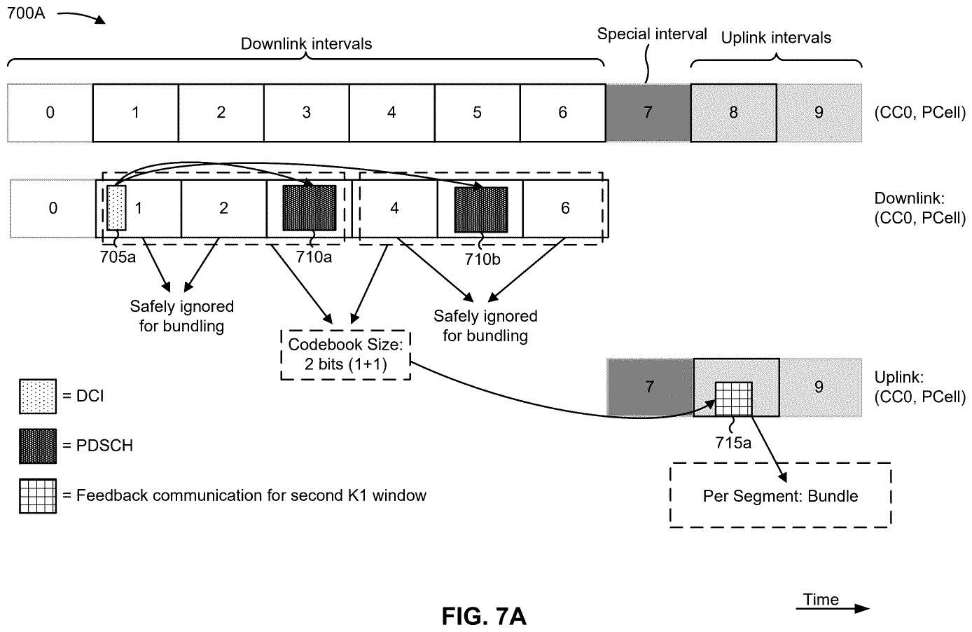

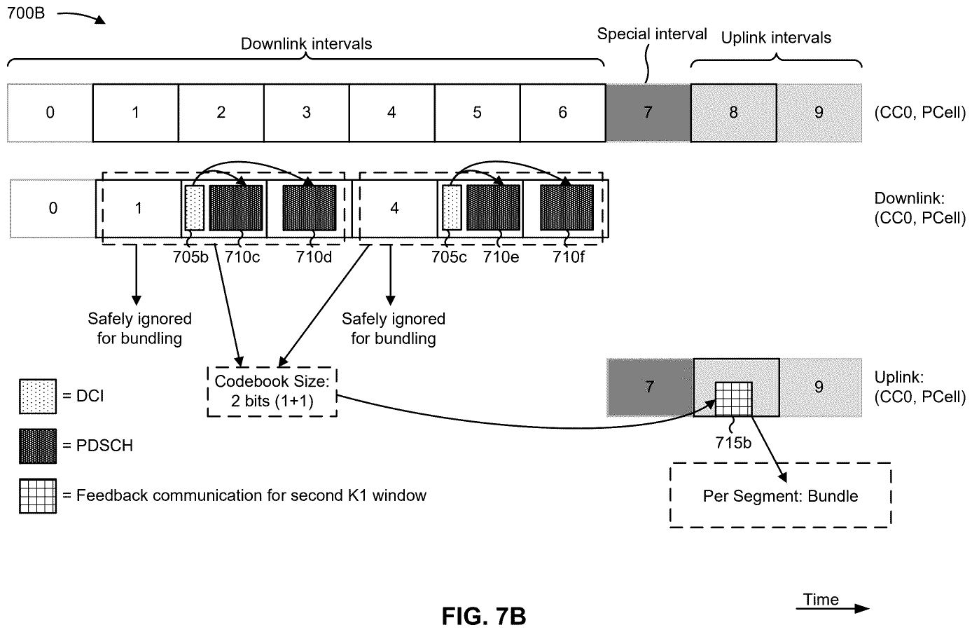

Therefore, in accordance with aspects of example 600D, each K1 window indicated in the configuration information may include a respective set of downlink time segments associated with the time domain and/or the frequency domain of the K1 window (where the downlink time segments are configured via the configuration information and/or configured by the UE 120). Such aspects of example 600D may result in one or more advantages. For example, by separating a K1 window into multiple downlink time segments, the associated Type-1 HARQ codebook may include more granular information associated with bundling feedback for a K1 window. Additionally, such downlink time segments enable flexibility at the UE 120 to identify which portions of a K1 window (in time and/or frequency) should be associated with respective feedback indications (e.g., respective bits) and which portions of the K1 window should be associated with a single feedback indication (e.g., a single bit). Further descriptions of downlink time segments are provided herein, including with reference to FIGS. 7A and 7B.

As indicated above, FIGS. 6A through 6D are provided as examples. Other examples may differ from what is described with regard to FIGS. 6A through 6D.

FIGS. 7A and 7B are diagrams illustrating examples 700A and 700B that illustrate a network node 110 scheduling one or more downlink messages during a TDD pattern, in accordance with the present disclosure. In some examples, the TDD pattern of FIGS. 7A and 7B may implement one or more aspects of the TDD pattern of FIGS. 6A through 6D. For example, the TDD pattern includes one or more downlink intervals, one or more special (or flexible) intervals, and one or more uplink intervals. Additionally, the TDD pattern may include a CC0, which may be an example of a PCell used for wireless communications between the network node 110 and the UE 120. Additionally, while FIGS. 7A and 7B illustrate communications via a single CC (e.g., CC0), the techniques and aspects described herein may be applied to a TDD pattern associated with a set of CCs (e.g., CC0, CC1, and CC2 as described with reference to FIGS. 6A through 6D).

As described elsewhere herein, multiple sets of interval offset information may be configured for semi-static HARQ codebooks (e.g., Type-1 HARQ codebooks). For example, a first interval offset information may include an interval offset of {7}, a second interval offset information may include interval offsets of {7, 6, 5, 4, 3, 2}, and a third interval offset information may include an interval offset of {2}. The first interval offset information may be a first K1 window, the second interval offset information may be a second K1 window, and the third interval offset information may be a third K1 window, described in FIGS. 7A and 7B. In some aspects, configuration information may indicate a pattern such that the special interval 7 is associated with the first interval offset information, the uplink interval 8 is associated with the second interval offset information, and the uplink interval 9 is associated with the third interval offset information shown in FIGS. 7A and 7B. Additionally, examples 700A and 700B primarily focus on the uplink interval 8 which is associated with the second interval offset information that corresponds to the second K1 window.

As shown in FIGS. 7A and 7B, the second K1 window for a Type-1 HARQ codebook to be transmitted during the uplink interval 8 may be based on the second interval offset information (e.g., the second K1 window) including interval offsets of {7, 6, 5, 4, 3, 2}. For example, as shown in FIGS. 7A and 7B, the downlink intervals 1 through 6 may be mapped to the uplink interval 8 for feedback communication. As a result, a feedback communication 715 (e.g., the Type-1 HARQ codebook) transmitted during the uplink interval 8 may have a size configured to indicate feedback for each possible downlink reception candidate that occurs during downlink intervals 1 through 6. Additionally, the second K1 window may be divided into multiple downlink time segments (e.g., similar to aspects of FIG. 6D). For example, the second K1 window may include a first downlink time segment that spans downlink intervals 1 through 3 and a second downlink time segment that spans downlink intervals 4 through 6.

As shown in FIGS. 7A and 7B, the network node 110 may transmit, and the UE 120 may receive, one or more DCIs 705 that schedule one or more PDSCHs 710 during the second K1 window. In some examples, the one or more PDSCHs 710 may be one or more PDSCH transport blocks. For example, the downlink intervals 1 through 6 may be examples of downlink slots, where the network node 110 may schedule one or more PDSCH transport blocks during one or more of the downlink slots. Additionally, uplink interval 8 may be an uplink slot. Therefore, each bit of the Type-1 HARQ codebook for feedback communication 715 may be associated with one or more downlink slots and may be associated with indicating ACK/NACK for PDSCH transport blocks. In some examples, the one or more PDSCHs 710 may be one or more CBGs of a PDSCH transport block. For example, the downlink intervals 1 through 6 may be downlink portions of one or more downlink slots, where the network node 110 may schedule one or more CBGs that are associated with a PDSCH transport block during one or more of the downlink portions. Additionally, the uplink interval 8 may be an uplink slot. Therefore, each bit of the Type-1 HARQ codebook for feedback communication 715 may be associated with one or more downlink portions of a slot and may be associated with indicating ACK/NACK for a CBG (e.g., CBG-based feedback). Additionally, the use of PDSCH 710 is an example of a type of downlink message that the network node 110 may schedule. However, in some other examples, the techniques of FIGS. 7A and 7B may be associated with other types of downlink messages, such as PDCCHs.

In some cases, the network node 110 may not schedule PDSCHs 710 during each of the downlink intervals 1 through 6 of the second K1 window. Therefore, in cases of multiplexed feedback, for downlink intervals during which the UE 120 does not receive a downlink message, the UE 120 may indicate a NACK indication in the associated bit of the Type-1 HARQ codebook for a feedback communication 715. However, in cases of bundled feedback, the UE 120 may be unaware of whether the network node 110 did not schedule a given downlink interval with a PDSCH 710, or if the UE 120 did not receive a DCI 705 that schedules the given downlink interval with a PDSCH 710. In other words, the UE 120 may be unable to distinguish between missing a DCI 705 that schedules a PDSCH 710 during a downlink, and a downlink interval that is not scheduled with a PDSCH 710. However, if the UE 120 is not aware of a reason why a PDSCH 710 is not received during a given downlink interval (e.g., missed DCI 705 or downlink interval is not scheduled), then the UE 120 may mistakenly indicate a NACK for the bundle feedback, even in cases where there was no PDSCH 710 scheduled. Such unawareness by the UE 120 may result in increases in NACK indications within the Type-1 HARQ codebook, which may increase retransmission of PDSCHs 710, even in cases where the UE 120 successfully received each scheduled PDSCH 710 for a given K1 window.

Therefore, to reduce the number of NACK indications associated with unawareness at the UE 120, the network node 110 and UE 120 may operate in accordance with one or more aspects of FIGS. 7A and 7B.

FIG. 7A is a diagram illustrating example 700A that illustrates downlink scheduling techniques associated with bundled feedback, in accordance with the present disclosure. For example, in accordance with example 700A, within a bundling unit (e.g., either a whole K1 window configured for bundled feedback or a downlink time segment of a K1 window configured for bundled feedback), the UE 120 does not expect to be scheduled with more than one PDSCH 710.

For example, as shown in FIG. 7A, the UE 120 may receive a DCI 705a that schedules a PDSCH 710a during downlink interval 3 and a PDSCH 710b during downlink interval 5. In some other examples, PDSCH 710a and PDSCH 710b may be scheduled by separate DCIs 705. In some examples, the UE 120 may receive the one or more DCIs 705 that schedule PDSCH 710a and PDSCH 710b during the associated K1 window, during the associated downlink time segment, before the associated K1 window, or before the associated downlink time segment.

In accordance with the techniques of example 700A, the network node 110 schedules at most a single PDSCH 710 per bundling unit. For instance, in example 700A, the bundling unit is per downlink time segment, and therefore the network node 110 schedules PDSCH 710a during uplink interval 3 of the first downlink time segment of the second K1 window and schedules PDSCH 710b during uplink interval 5 of the second downlink time segment of the second K1 window. Based on being scheduled with the PDSCH 710a during downlink interval 3, the UE 120 may safely ignore downlink interval 1 and downlink interval 2 in accordance with the network node 110 scheduling at most one PDSCH per bundling unit (e.g., one PDSCH during the first downlink time segment). Additionally, based on being scheduled with the PDSCH 710b during downlink interval 5, the UE 120 may safely ignore downlink interval 4 and downlink interval 6 in accordance with the network node 110 scheduling at most one PDSCH per bundling unit (e.g., one PDSCH during the second downlink time segment). In accordance with example 700A, the Type-1 HARQ codebook of the feedback communication 715a may include a first single bit associated with the first downlink time segment and a second single bit associated with the second downlink time segment. However, in another example the bundling unit may include the entire second K1 window. In such an example, the network node 110 may schedule at most one PDSCH 710 during downlink interval 1 through 6 and the Type-1 HARQ codebook of the feedback communication 715a may include a single bit associated with the entire second K1 window. If the bundling unit is the entire second K1 window and no PDSCHs are scheduled during the second K1 window, then the UE 120 may refrain from sending the feedback communication 715a, which may reduce signaling overhead. If the bundling unit is per downlink time segment of the second K1 window, and no PDSCHs are scheduled during a given downlink time segment, then the UE 120 may indicate a NACK via the bit of the Type-1 HARQ codebook in the feedback communication 715a associated with the given downlink time segment, which may increase granularity in feedback associated with respective downlink time segments.

In some examples, the network node 110 may transmit, and the UE 120 may receive, configuration information that configures one or more aspects of the example 700A. In some examples, the configuration information may be the same configuration information as described with reference to FIGS. 6A through 6D. In some examples, one or more aspects of example 700A may be defined in a wireless communications standard, such as 3GPP. In some examples, configuration information may indicate, and/or the UE 120 may determine to operate in accordance with, one or more aspects of example 700A if a density of traffic associated with the TDD pattern satisfies (e.g., is below) a threshold (e.g., a number of downlink messages scheduled during a period of the TDD pattern satisfies the threshold).

By operating in accordance with aspects of example 700A, the UE 120 and network node 110 may benefit from one or more advantages. For example, by scheduling at most one PDSCH 710 per bundling unit (e.g., per downlink time segment or per K1 window), the UE 120 may experience an increase in awareness of whether a downlink interval is not scheduled with a PDSCH 710 or whether the UE 120 missed a DCI 705 that schedules a PDSCH 710 during a downlink interval. Such increases in awareness may reduce an occurrence of NACK indications in the Type-1 HARQ feedback, which may reduce retransmissions of PDSCHs 710 that the UE 120 already successfully received, which may further reduce signaling overhead.

FIG. 7B is a diagram illustrating example 700B that illustrates downlink scheduling techniques associated with bundled feedback, in accordance with the present disclosure. For example, in accordance with example 700B, within a bundling unit (e.g., either a whole K1 window configured for bundled feedback or a downlink time segment of a K1 window configured for bundled feedback), the UE 120 does not expect to be scheduled with one or more PDSCHs 710 that are granted (e.g., scheduled) by more than one downlink grant.

For example, as shown in FIG. 7B, the UE 120 may receive a DCI 705b (e.g., a first downlink grant) that schedules a PDSCH 710c during downlink interval 2 and schedules a PDSCH 710d during downlink interval 3. Additionally, the UE 120 may receive a DCI 705c (e.g., a second downlink grant) that schedules a PDSCH 710e during downlink interval 5 and schedules a PDSCH 710f during downlink interval 6. In other words, each bundling unit (e.g., the first downlink time segment and the second downlink time segment) is associated with at most one DCI 705 that schedules one or more PDSCHs 710 during the associated bundling unit. In some examples, the UE 120 may receive DCI 705b during a downlink interval associated with the first downlink time segment or during a downlink interval prior to the first downlink time segment. Additionally, in some examples, the UE 120 may receive DCI 705c during a downlink interval associated with second downlink time segment or during a downlink interval prior to the second downlink time segment.

In accordance with the techniques of example 700B, the network node 110 schedules at most a single DCI 705 associated with PDSCHs 710 of a given bundling unit. For instance, in example 700B, the bundling unit is per downlink time segment, and therefore the network node 110 schedules DCI 705b which is associated with the first downlink time segment and schedules DCI 705c which is associated with the second downlink time segment. In some aspects of example 700B, the network node 110 may schedule multiple PDSCHs 710 with a multi-TTI downlink DCI (e.g., scheduling multiple PDSCHs in a time domain). Additionally, or alternatively, the network node 110 may schedule multiple PDSCHs 710 with a multi-CC downlink DCI (e.g., scheduling multiple PDSCHs in the CC domain). For instance, multi-CC downlink DCI may schedule multiple PDSCHs across multiple CCs associated with a bundling unit of the TDD pattern.

Based on each bundling unit being associated with at most a single DCI 705 that schedules one or more PDSCHs 710, the UE 120 may safely ignore all downlink intervals of a given bundling unit that are not scheduled with a PDSCH 710. For example, the UE 120 may safely ignore downlink interval 1 of the first downlink time segment and may safely ignore downlink interval 4 of the second downlink time segment (e.g., not consider downlink intervals 1 and 4 while determining the bundled feedback for feedback communication 715b). In accordance with example 700B, the Type-1 HARQ codebook of the feedback communication 715b may include a first single bit associated with the first downlink time segment and a second single bit associated with the second downlink time segment. However, in another example, the bundling unit may include the entire second K1 window. In such an example, the network node 110 may schedule at most one DCI 705 that is associated with scheduling one or more PDSCHs 710 during the second K1 window, and the Type-1 HARQ codebook of the feedback communication 715b may include a single bit associated with the entire second K1 window. If the bundling unit is the entire second K1 window and no PDSCHs 710 are scheduled during the second K1 window, then the UE 120 may refrain from sending the feedback communication 715b, which may reduce signaling overhead. If the bundling unit is per downlink time segment of second K1 window, and no PDSCHs 710 are scheduled during a given downlink time segment, then the UE 120 may indicate a NACK via the bit of the Type-1 HARQ codebook in the feedback communication 715b associated with the given downlink time segment, which may increase granularity in feedback associated with respective downlink time segments.

In some examples, the network node 110 may transmit to the UE 120 configuration information that configures one or more aspects of the example 700B. In some examples, the configuration information may be the same configuration information as described with reference to FIGS. 6A through 6D. In some examples, one or more aspects of example 700B may be defined in a wireless communications standard, such as 3GPP.

By operating in accordance with aspects of example 700B, the UE 120 and network node 110 may benefit from one or more advantages. For example, by scheduling at most one DCI 705 that is associated with scheduling PDSCHs 710 per bundling unit (e.g., per downlink time segment or per K1 window), the UE 120 may experience an increase in awareness of whether a downlink interval is not scheduled with a PDSCH 710 or whether the UE 120 missed a DCI 705 that schedules one or more PDSCHs during a bundling unit. Such increases in awareness may reduce an occurrence of NACK indications in the Type-1 HARQ feedback, which may reduce retransmissions of PDSCHs 710 that the UE 120 already successfully received, which may further reduce signaling overhead.

As indicated above, FIGS. 7A and 7B are provided as examples. Other examples may differ from what is described with regard to FIGS. 7A and 7B.

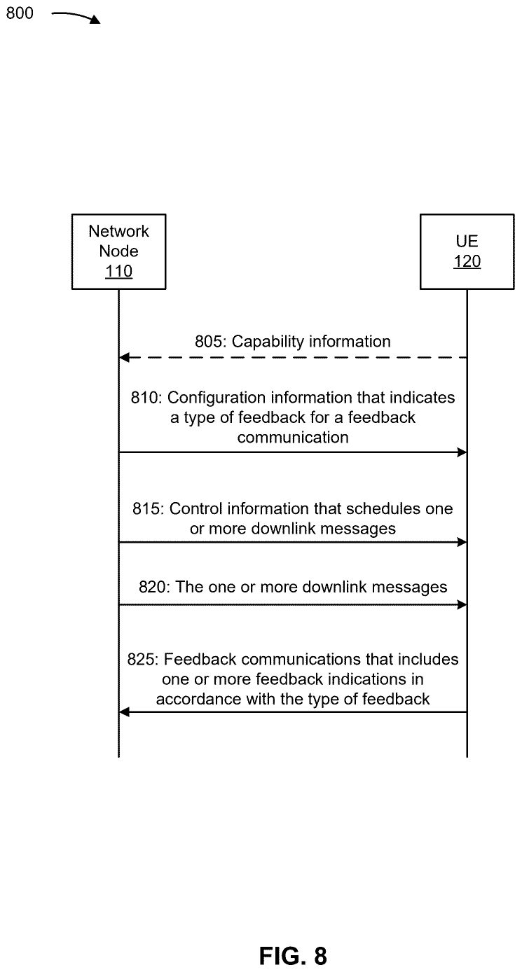

FIG. 8 is a diagram illustrating an example 800 associated with multiplexing and bundling techniques for feedback communications, in accordance with the present disclosure. Example 800 may implement or be implemented by one or more aspects of FIGS. 1 through 7B. For instance, example 800 includes wireless communications between the UE 120 and the network node 110. Alternative examples of the following may be implemented, where some operations are performed in a different order than described, or not described at all. In some cases, one or more operations may include additional features not mentioned below, or further operations may be added. In addition, while example 800 shows operations between the UE 120 and the network node 110, the communication may occur between any number of network devices of various types described herein.

In some aspects, as shown by a first operation 805, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, an SCI communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in the capability report.

The capability information may indicate whether the UE 120 supports a feature and/or one or more parameters related to the feature. For example, the capability information may indicate a capability and/or parameter for supporting multiplexing and/or bundling techniques associated with a set of interval offset information being indicated for semi-static HARQ codebooks (e.g., a Type-1 HARQ codebook). In some examples, the capability information may indicate a capability and/or parameter for supporting multiple K1 windows being configured as part of a Type-1 HARQ codebook configuration. Additionally, the capability information may indicate a capability and/or a parameter for supporting multiple types of feedback as part of the Type-1 HARQ codebook configuration. For example, the multiple types of feedback may include multiplexed feedback and/or bundled feedback, as described with reference to FIGS. 6A through 7B. One or more operations described herein may be based on capability information. For example, the UE 120 may perform a communication in accordance with the capability information or may receive configuration information that is in accordance with the capability information.

The network node 110 may determine configuration information for the UE 120 based on the capability information. For example, the network node 110 may determine that the UE 120 is to be configured with multiple K1 windows corresponding to respective uplink intervals of a TDD pattern and/or multiple K1 windows corresponding to respective sets of downlink intervals of the TDD pattern based on the capability information indicating that the UE 120 supports multiple sets of interval offset information for a given HARQ codebook type. Additionally, the network node 110 may determine that the UE 120 is to operate in accordance with multiplexed feedback and/or bundled feedback based on the capability information indicating that the UE 120 supports multiplexed feedback and/or bundled feedback in accordance with the Type-1 HARQ codebook. In other examples, the network node 110 may determine the configuration information without, or independently of, the capability information. For example, the network node 110 may determine that the UE 120 supports multiple sets of interval offset information for a given HARQ codebook type and/or that the UE 120 supports multiplexed feedback and/or bundled feedback for Type-1 HARQ codebook as described herein based on a type, category, or other classification of the UE 120.

In a second operation 810, the network node 110 may transmit, and the UE 120 may receive, the configuration information. In some aspects, the UE 120 may receive the configuration information via one or more of system information signaling (e.g., a MIB and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate whether a feedback communication, that is scheduled during an uplink interval, is associated with a first type of feedback (e.g., multiplexed feedback) or a second type of feedback (e.g., bundled feedback). In some examples, the feedback communication may be associated with data received during one or more downlink intervals. Additionally, the configuration information may be specific to the uplink interval. As an example, with reference to FIGS. 6A through 6D, the configuration information may be specific to the uplink interval 8, where the uplink interval 8 is associated with downlink intervals 3 through 6 (e.g., the second K1 window), and where the configuration information indicates whether the uplink interval 8 is associated with multiplexed feedback and/or bundled feedback. In some aspects, the configuration information may be specific to multiple uplink intervals. For instance, with reference to FIGS. 6A through 6D, the configuration information may respectively indicate whether each of special interval 7, uplink interval 8, and uplink interval 9 are associated with multiplexed feedback and/or bundled feedback. That is, the configuration information may respectively configure a type of feedback for multiple uplink intervals associated with a TDD pattern.

In some aspects, the configuration information indicates that the one or more downlink intervals and the uplink interval are part of a periodic time interval, and indicates that the feedback communication is periodically configured to be associated with the multiplexed feedback or the bundled feedback. For example, the configuration information indicates that the one or more downlink intervals and the uplink interval are associated with a periodic TDD pattern.

In some aspects, the one or more downlink intervals are associated with a set of CCs (e.g., CC0, CC1, and CC2, in accordance with FIG. 6A though 6D) and the one or more downlink messages are received in respective CCs of the set of CCs. In some examples, the configuration information indicates for the set of CCs to each separately apply the first type of feedback or to each separately apply the second type of feedback (e.g., in accordance with the aspects of FIG. 6A). In some examples, the configuration information separately indicates, for each CC of the set of CCs, whether to apply the first type of feedback or the second type of feedback (e.g., in accordance with FIG. 6B). In some examples, the configuration information indicates one or more subsets of CCs from the set of CCs and separately indicates, for each subset of CCs of the one or more subsets of CCs, whether to apply the first type of feedback or the second type of feedback (e.g., in accordance with FIG. 6C). In some examples, the configuration information indicates for the feedback communication to include the single feedback indication for the one or more downlink messages across the set of CCs (e.g., feedback communication 615c, in accordance with FIG. 6C).

In some aspects, the one or more downlink intervals are included in a downlink time segment of multiple downlink time segments that span a downlink time window (e.g., a K1 window associated with an uplink interval). In some examples, configuration information separately indicates, for each downlink time segment of the multiple downlink time segments, whether the feedback communication is associated with multiplexed feedback or bundled feedback (e.g., in accordance with FIG. 6D). In some examples, the bundled feedback is applied separately to the multiple downlink time segments (e.g., in accordance with FIG. 6D). In some examples, the downlink time segment is associated with one or more of a subset of downlink time intervals included in the downlink time window, one or more CCs of a set of CCs associated with the downlink time window, or one or more codewords of a set of codewords associated with the downlink time window (e.g., in accordance with FIG. 6D).

In a third operation 815, the network node 110 may transmit, and the UE 120 may receive, control information that schedules one or more downlink messages during the one or more downlink intervals of the TDD period. Additionally, the one or more downlink intervals may be associated with a time period that spans a downlink time window (e.g., a K1 window) or spans a downlink time segment of the downlink time window. In some examples, the control information schedules a single downlink message of the one or more downlink messages during the time period (e.g., in accordance with FIG. 7A). In some examples, the control information may be a single downlink grant that schedules one or more downlink messages of the one or more downlink messages during the time period (e.g., in accordance with FIG. 7B).

In some aspects, the one or more downlink messages are one or more PDSCH transport blocks, the one or more downlink intervals are one or more downlink slots, and the feedback communication is a Type-1 HARQ codebook communication. In some aspects, the one or more downlink messages are one or more CBGs included in a PDSCH transport block, the one or more downlink intervals are one or more portions of a slot associated with the PDSCH transport block, and the feedback communication is a CBG feedback communication associated with a Type-1 HARQ codebook.

In a fourth operation 820, the network node 110 may transmit, and the UE 120 may receive during the one or more downlink intervals, the one or more downlink messages. For example, the one or more downlink messages may be one or more PDSCH transport blocks and/or one or more CBGs included in a PDSCH transport block.

In a fifth operation 825, the UE 120 may transmit, and the network node 110 may receive, the feedback communication in accordance with the configuration information. For example, the feedback may include feedback indications associated with respective downlink messages of the one or more downlink messages in accordance with multiplexed feedback (e.g., the first type of feedback) or a single feedback indication associated with the one or more downlink messages in accordance with the bundled feedback (e.g., the second type of feedback). For example, the feedback communication includes a feedback codebook having a fixed size (e.g., a Type-1 HARQ codebook).

In examples of multiplexed feedback, downlink intervals of the one or more downlink intervals are associated with respective bits included in the Type-1 HARQ codebook. For instance, a given bit associated with multiplexed feedback included in the Type-1 HARQ codebook is one of a first value or a second value. The first value indicates that a downlink message of the one or more downlink messages was successfully received during a downlink interval that is associated with the given bit (e.g., ACK indication). The second value that indicates that a downlink message was not received or not scheduled during the downlink interval that is associated with the given bit (e.g., NACK indication).

In examples of bundled feedback, the one or more downlink messages scheduled during the one or more downlink intervals are associated with a single bit included in the Type-1 HARQ codebook. For instance, the single bit associated with bundled feedback included in the Type-1 HARQ codebook is one of a first value or a second value. The first value indicates that each downlink message of the one or more downlink messages was successfully received during the one or more downlink intervals associated with the single bit (e.g., ACK indication). The second value indicates that at least one downlink message of the one or more downlink messages was not received during the one or more downlink intervals associated with the single bit (e.g., NACK indication).

In accordance with receiving the feedback communication, the network node 110 may determine whether to retransmit one or more of the one or more downlink messages. For example, if the Type-1 HARQ codebook indicates multiplexed feedback, the network node 110 may determine that the UE 120 did not receive downlink messages during downlink intervals indicated to be associated with the second value (e.g., NACK) in the Type-1 HARQ codebook. Therefore, the network node 110 may determine to retransmit the downlink messages associated with downlink intervals that are associated with the second value. If the Type-1 HARQ codebook indicates bundled feedback associated with the second value (e.g., NACK), the network node 110 may determine to retransmit all of the downlink messages transmitted during the one or more downlink messages associated with the bundled feedback. In some examples, the network node 110 may retransmit the downlink messages determined for retransmission during a subsequent period of the TDD pattern.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with multiplexing and bundling techniques for feedback communications.

As shown in FIG. 9, in some aspects, process 900 may include receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval (block 910). For example, the UE (e.g., using reception component 1102 and/or communication manager 1106, depicted in FIG. 11) may receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval, as described above.

As further shown in FIG. 9, in some aspects, process 900 may include receiving, from the network node during the one or more downlink intervals, one or more downlink messages (block 920). For example, the UE (e.g., using reception component 1102 and/or communication manager 1106, depicted in FIG. 11) may receive, from the network node during the one or more downlink intervals, one or more downlink messages, as described above.

As further shown in FIG. 9, in some aspects, process 900 may include transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback (block 930). For example, the UE (e.g., using transmission component 1104 and/or communication manager 1106, depicted in FIG. 11) may transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback, as described above.

Process 900 may include additional aspects, such as any single aspect or any combination of aspects described below and/or in connection with one or more other processes described elsewhere herein.

In a first aspect, the feedback communication includes a feedback codebook having a fixed size, and the feedback codebook includes one or more of multiplexing feedback associated with the first type of feedback, wherein downlink intervals of the one or more downlink intervals are associated with respective bits included in the feedback codebook, or bundling feedback associated with the second type of feedback, wherein the one or more downlink messages scheduled during the one or more downlink intervals are associated with a single bit included in the feedback codebook.

In a second aspect, a bit associated with multiplexed feedback included in the feedback codebook is one of a first value that indicates that a downlink message of the one or more downlink messages was successfully received during a downlink interval that is associated with the bit, or a second value that indicates that a downlink message was not received or not scheduled during the downlink interval that is associated with the bit.

In a third aspect, the single bit associated with bundled feedback included in the feedback codebook is one of a first value that indicates that each downlink message of the one or more downlink messages was successfully received during the one or more downlink intervals associated with the single bit, or a second value that indicates that at least one downlink message of the one or more downlink messages was not received during the one or more downlink intervals associated with the single bit.

In a fourth aspect, the configuration information indicates that the one or more downlink intervals and the uplink interval are part of a periodic time interval, and indicates that the feedback communication is periodically configured to be associated with the first type of feedback or the second type of feedback.

In a fifth aspect, the one or more downlink intervals are associated with a set of CCs and the one or more downlink messages are received in respective CCs of the set of CCs.

In a sixth aspect, the configuration information indicates for the set of CCs to each separately apply the first type of feedback or to each separately apply the second type of feedback.

In a seventh aspect, the configuration information separately indicates, for each CC of the set of CCs, whether to apply the first type of feedback or the second type of feedback.

In an eighth aspect, the configuration information indicates one or more subsets of CCs from the set of CCs and separately indicates, for each subset of CCs of the one or more subsets of CCs, whether to apply the first type of feedback or the second type of feedback.

In a ninth aspect, the configuration information indicates for the feedback communication to include the single feedback indication for the one or more downlink messages across the set of CCs.

In a tenth aspect, the one or more downlink intervals are included in a downlink time segment of multiple downlink time segments that span a downlink time window.

In an eleventh aspect, the configuration information separately indicates, for each downlink time segment of the multiple downlink time segments, whether the feedback communication is associated with first type of feedback or the second type of feedback.

In a twelfth aspect, the second type of feedback is applied separately to the multiple downlink time segments.

In a thirteenth aspect, the downlink time segment is associated with one or more of a subset of downlink time intervals included in the downlink time window, one or more CCs of a set of CCs associated with the downlink time window, or one or more codewords of a set of codewords associated with the downlink time window.

In a fourteenth aspect, the one or more downlink intervals are associated with a time period that spans a downlink time window or spans a downlink time segment of the downlink time window, and process 900 includes receiving, from the network node, control information that schedules a single downlink message of the one or more downlink messages during the time period, wherein receiving the single downlink message is in accordance with the configuration information.

In a fifteenth aspect, the one or more downlink intervals are associated with a time period that spans a downlink time window or spans a downlink time segment of the downlink time window, and process 900 includes receiving, from the network node, a single downlink grant that schedules one or more downlink messages of the one or more downlink messages during the time period, wherein receiving the single downlink grant is in accordance with the configuration information.

In a sixteenth aspect, the one or more downlink messages are one or more PDSCH transport blocks, the one or more downlink intervals are one or more downlink slots, and the feedback communication is a Type-1 HARQ codebook communication.

In a seventeenth aspect, the one or more downlink messages are one or more code block groups included in a PDSCH transport block, the one or more downlink intervals are one or more portions of a slot associated with the PDSCH transport block, and the feedback communication is a CBG feedback communication associated with a Type-1 HARQ codebook.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with multiplexing and bundling techniques for feedback communications.

As shown in FIG. 10, in some aspects, process 1000 may include transmitting, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval (block 1010). For example, the network node (e.g., using transmission component 1204 and/or communication manager 1206, depicted in FIG. 12) may transmit, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval, as described above.

As further shown in FIG. 10, in some aspects, process 1000 may include transmitting, to the UE during the one or more downlink intervals, a one or more downlink messages (block 1020). For example, the network node (e.g., using transmission component 1204 and/or communication manager 1206, depicted in FIG. 12) may transmit, to the UE during the one or more downlink intervals, a one or more downlink messages, as described above.

As further shown in FIG. 10, in some aspects, process 1000 may include receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback (block 1030). For example, the network node (e.g., using reception component 1202 and/or communication manager 1206, depicted in FIG. 12) may receive, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback, as described above.

Process 1000 may include additional aspects, such as any single aspect or any combination of aspects described below and/or in connection with one or more other processes described elsewhere herein.

In a first aspect, the feedback communication includes a feedback codebook having a fixed size, and the feedback codebook includes one or more of multiplexing feedback associated with the first type of feedback, wherein downlink intervals of the one or more downlink intervals are associated with respective bits included in the feedback codebook, or bundling feedback associated with the second type of feedback, wherein the one or more downlink messages scheduled during the one or more downlink intervals are associated with a single bit included in the feedback codebook.

In a second aspect, a bit associated with multiplexed feedback included in the feedback codebook is one of a first value that indicates that a downlink message of the one or more downlink messages was successfully received during a downlink interval associated with the bit, or a second value that indicates that a downlink message was not received or not scheduled during the downlink interval that is associated with the bit.

In a third aspect, the single bit associated with bundled feedback included in the feedback codebook is one of a first value that indicates that each downlink message of the one or more downlink messages was successfully received during the one or more downlink intervals associated with the single bit, or a second value that indicates that at least one downlink message of the one or more downlink messages was not received during the one or more downlink intervals associated with the single bit.

In a fourth aspect, the configuration information indicates that the one or more downlink intervals and the uplink interval are part of a periodic time interval and indicates that the feedback communication is periodically configured to be associated with the first type of feedback or the second type of feedback.

In a fifth aspect, the one or more downlink intervals are associated with a set of CCs and the one or more downlink messages are received in respective CCs of the set of CCs.

In a sixth aspect, the configuration information indicates for the set of CCs to each separately apply the first type of feedback or to each separately apply the second type of feedback.

In a seventh aspect, the configuration information separately indicates, for each CC of the set of CCs, whether to apply the first type of feedback or the second type of feedback.

In an eighth aspect, the configuration information indicates one or more subsets of CCs from the set of CCs and separately indicates, for each subset of CCs of the one or more subsets of CCs, whether to apply the first type of feedback or the second type of feedback.

In a ninth aspect, the configuration information indicates for the feedback communication to include the single feedback indication for the one or more downlink messages across the set of CCs.

In a tenth aspect, the one or more downlink intervals are included in a downlink time segment of multiple downlink time segments that span a downlink time window.

In an eleventh aspect, the configuration information separately indicates, for each downlink time segment of the multiple downlink time segments, whether the feedback communication is associated with first type of feedback or the second type of feedback.

In a twelfth aspect, the second type of feedback is applied separately to the multiple downlink time segments.

In a thirteenth aspect, the downlink time segment is associated with one or more of a subset of downlink time intervals included in the downlink time window, one or more CCs of a set of CCs associated with the downlink time window, or one or more codewords of a set of codewords associated with the downlink time window.

In a fourteenth aspect, the one or more downlink intervals are associated with a time period that spans a downlink time window or spans a downlink time segment of the downlink time window, and process 1000 includes transmitting, to the UE, control information that schedules a single downlink message of the one or more downlink messages during the time period, wherein receiving the single downlink message is in accordance with the configuration information.

In a fifteenth aspect, the one or more downlink intervals are associated with a time period that spans a downlink time window or spans a downlink time segment of the downlink time window, and process 1000 includes transmitting, to the UE, a single downlink grant that schedules one or more downlink messages of the one or more downlink messages during the time period, wherein receiving the single downlink grant is in accordance with the configuration information.

In a sixteenth aspect, the one or more downlink messages are one or more PDSCH transport blocks, the one or more downlink intervals are one or more downlink slots, and the feedback communication is a Type-1 HARQ codebook communication.

In a seventeenth aspect, the one or more downlink messages are one or more code blocks included in a PDSCH transport block, the one or more downlink intervals are one or more portions of a slot associated with the PDSCH transport block, and the feedback communication is a CBG feedback communication associated with a Type-1 HARQ codebook.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 6 through 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The reception component 1102 may receive, from the network node during the one or more downlink intervals, one or more downlink messages. The transmission component 1104 may transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 6 through 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval. The transmission component 1204 may transmit, to the UE during the one or more downlink intervals, a one or more downlink messages. The reception component 1202 may receive, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; receiving, from the network node during the one or more downlink intervals, one or more downlink messages; and transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Aspect 2: The method of Aspect 1, wherein the feedback communication includes a feedback codebook having a fixed size, and wherein the feedback codebook includes one or more of: multiplexed feedback associated with the first type of feedback, wherein downlink intervals of the one or more downlink intervals are associated with respective bits included in the feedback codebook, or bundled feedback associated with the second type of feedback, wherein the one or more downlink messages scheduled during the one or more downlink intervals are associated with a single bit included in the feedback codebook.

Aspect 3: The method of Aspect 2, wherein a bit associated with multiplexed feedback included in the feedback codebook is one of: a first value that indicates that a downlink message of the one or more downlink messages was successfully received during a downlink interval that is associated with the bit, or a second value that indicates that a downlink message was not received or not scheduled during the downlink interval that is associated with the bit.

Aspect 4: The method of Aspect 2, wherein the single bit associated with bundled feedback included in the feedback codebook is one of: a first value that indicates that each downlink message of the one or more downlink messages was successfully received during the one or more downlink intervals associated with the single bit, or a second value that indicates that at least one downlink message of the one or more downlink messages was not received during the one or more downlink intervals associated with the single bit.

Aspect 5: The method of any of Aspects 1-4, wherein the configuration information indicates that the one or more downlink intervals and the uplink interval are part of a periodic time interval, and indicates that the feedback communication is periodically configured to be associated with the first type of feedback or the second type of feedback.

Aspect 6: The method of any of Aspects 1-5, wherein the one or more downlink intervals are associated with a set of component carriers and the one or more downlink messages are received in respective component carriers of the set of component carriers.

Aspect 7: The method of Aspect 6, wherein the configuration information indicates for the set of component carriers to each separately apply the first type of feedback or to each separately apply the second type of feedback.

Aspect 8: The method of Aspect 6, wherein the configuration information separately indicates, for each component carrier of the set of component carriers, whether to apply the first type of feedback or the second type of feedback.

Aspect 9: The method of Aspect 6, wherein the configuration information indicates one or more subsets of component carriers from the set of component carriers and separately indicates, for each subset of component carriers of the one or more subsets of component carriers, whether to apply the first type of feedback or the second type of feedback.

Aspect 10: The method of Aspect 6, wherein the configuration information indicates for the feedback communication to include the single feedback indication for the one or more downlink messages across the set of component carriers.

Aspect 11: The method of any of Aspects 1-10, wherein the one or more downlink intervals are included in a downlink time segment of multiple downlink time segments that span a downlink time window.

Aspect 12: The method of Aspect 11, wherein the configuration information separately indicates, for each downlink time segment of the multiple downlink time segments, whether the feedback communication is associated with first type of feedback or the second type of feedback.

Aspect 13: The method of Aspect 11, wherein the second type of feedback is applied separately to the multiple downlink time segments.

Aspect 14: The method of Aspect 11, wherein the downlink time segment is associated with one or more of a subset of downlink time intervals included in the downlink time window, one or more component carriers of a set of component carriers associated with the downlink time window, or one or more codewords of a set of codewords associated with the downlink time window.

Aspect 15: The method of any of Aspects 1-14, wherein the one or more downlink intervals are associated with a time period that spans a downlink time window or spans a downlink time segment of the downlink time window, the method further comprising: receiving, from the network node, control information that schedules a single downlink message of the one or more downlink messages during the time period, wherein receiving the single downlink message is in accordance with the configuration information.

Aspect 16: The method of any of Aspects 1-15, wherein the one or more downlink intervals are associated with a time period that spans a downlink time window or spans a downlink time segment of the downlink time window, the method further comprising: receiving, from the network node, a single downlink grant that schedules one or more downlink messages of the one or more downlink messages during the time period, wherein receiving the single downlink grant is in accordance with the configuration information.

Aspect 17: The method of any of Aspects 1-16, wherein the one or more downlink messages are one or more physical downlink shared channel (PDSCH) transport blocks, the one or more downlink intervals are one or more downlink slots, and the feedback communication is a Type-1 hybrid automatic repeat request (HARQ) codebook communication.

Aspect 18: The method of any of Aspects 1-17, wherein the one or more downlink messages are one or more code block groups included in a physical downlink shared channel (PDSCH) transport block, the one or more downlink intervals are one or more portions of a slot associated with the PDSCH transport block, and the feedback communication is a code block group (CBG) feedback communication associated with a Type-1 hybrid automatic repeat request (HARQ) codebook.

Aspect 19: A method of wireless communication performed by a network node, comprising: transmitting, to a user equipment (UE), configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval; transmitting, to the UE during the one or more downlink intervals, a one or more downlink messages; and receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

Aspect 20: The method of Aspect 19, wherein the feedback communication includes a feedback codebook having a fixed size, and wherein the feedback codebook includes one or more of: multiplexed feedback associated with the first type of feedback, wherein downlink intervals of the one or more downlink intervals are associated with respective bits included in the feedback codebook, or bundled feedback associated with the second type of feedback, wherein the one or more downlink messages scheduled during the one or more downlink intervals are associated with a single bit included in the feedback codebook.

Aspect 21: The method of Aspect 20, wherein a bit associated with multiplexed feedback included in the feedback codebook is one of: a first value that indicates that a downlink message of the one or more downlink messages was successfully received during a downlink interval associated with the bit, or a second value that indicates that a downlink message was not received or not scheduled during the downlink interval that is associated with the bit.

Aspect 22: The method of Aspect 20, wherein the single bit associated with bundled feedback included in the feedback codebook is one of: a first value that indicates that each downlink message of the one or more downlink messages was successfully received during the one or more downlink intervals associated with the single bit, or a second value that indicates that at least one downlink message of the one or more downlink messages was not received during the one or more downlink intervals associated with the single bit.

Aspect 23: The method of any of Aspects 19-22, wherein the configuration information indicates that the one or more downlink intervals and the uplink interval are part of a periodic time interval and indicates that the feedback communication is periodically configured to be associated with the first type of feedback or the second type of feedback.

Aspect 24: The method of any of Aspects 19-23, wherein the one or more downlink intervals are associated with a set of component carriers and the one or more downlink messages are received in respective component carriers of the set of component carriers.

Aspect 25: The method of Aspect 24, wherein the configuration information indicates for the set of component carriers to each separately apply the first type of feedback or to each separately apply the second type of feedback.

Aspect 26: The method of Aspect 24, wherein the configuration information separately indicates, for each component carrier of the set of component carriers, whether to apply the first type of feedback or the second type of feedback.

Aspect 27: The method of Aspect 24, wherein the configuration information indicates one or more subsets of component carriers from the set of component carriers and separately indicates, for each subset of component carriers of the one or more subsets of component carriers, whether to apply the first type of feedback or the second type of feedback.

Aspect 28: The method of Aspect 24, wherein the configuration information indicates for the feedback communication to include the single feedback indication for the one or more downlink messages across the set of component carriers.

Aspect 29: The method of any of Aspects 19-28, wherein the one or more downlink intervals are included in a downlink time segment of multiple downlink time segments that span a downlink time window.

Aspect 30: The method of Aspect 29, wherein the configuration information separately indicates, for each downlink time segment of the multiple downlink time segments, whether the feedback communication is associated with first type of feedback or the second type of feedback.

Aspect 31: The method of Aspect 29, wherein the second type of feedback is applied separately to the multiple downlink time segments.

Aspect 32: The method of Aspect 29, wherein the downlink time segment is associated with one or more of a subset of downlink time intervals included in the downlink time window, one or more component carriers of a set of component carriers associated with the downlink time window, or one or more codewords of a set of codewords associated with the downlink time window.

Aspect 33: The method of any of Aspects 19-32, wherein the one or more downlink intervals are associated with a time period that spans a downlink time window or spans a downlink time segment of the downlink time window, the method further comprising: transmitting, to the UE, control information that schedules a single downlink message of the one or more downlink messages during the time period, wherein receiving the single downlink message is in accordance with the configuration information.

Aspect 34: The method of any of Aspects 19-33, wherein the one or more downlink intervals are associated with a time period that spans a downlink time window or spans a downlink time segment of the downlink time window, the method further comprising: transmitting, to the UE, a single downlink grant that schedules one or more downlink messages of the one or more downlink messages during the time period, wherein receiving the single downlink grant is in accordance with the configuration information.

Aspect 35: The method of any of Aspects 19-34, wherein the one or more downlink messages are one or more physical downlink shared channel (PDSCH) transport blocks, the one or more downlink intervals are one or more downlink slots, and the feedback communication is a Type-1 hybrid automatic repeat request (HARQ) codebook communication.

Aspect 36: The method of any of Aspects 19-35, wherein the one or more downlink messages are one or more code blocks included in a physical downlink shared channel (PDSCH) transport block, the one or more downlink intervals are one or more portions of a slot associated with the PDSCH transport block, and the feedback communication is a code block group (CBG) feedback communication associated with a Type-1 hybrid automatic repeat request (HARQ) codebook.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 38: An apparatus for wireless communication at a device, the apparatus comprising one or more memories and one or more processors coupled to the one or more memories, the one or more processors configured to cause the device to perform the method of one or more of Aspects 1-36.

Aspect 39: An apparatus for wireless communication, the apparatus comprising at least one means for performing the method of one or more of Aspects 1-36.

Aspect 40: A non-transitory computer-readable medium storing code for wireless communication, the code comprising instructions executable by one or more processors to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: A device for wireless communication, the device comprising a processing system that includes one or more processors and one or more memories coupled with the one or more processors, the processing system configured to cause the device to perform the method of one or more of Aspects 1-36.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval;
receive, from the network node during the one or more downlink intervals, one or more downlink messages; and
transmit, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

2. The UE of claim 1, wherein the feedback communication includes a feedback codebook having a fixed size, and wherein the feedback codebook includes one or more of:
multiplexed feedback associated with the first type of feedback, wherein downlink intervals of the one or more downlink intervals are associated with respective bits included in the feedback codebook, or
bundled feedback associated with the second type of feedback, wherein the one or more downlink messages scheduled during the one or more downlink intervals are associated with a single bit included in the feedback codebook.

3. The UE of claim 2, wherein a bit associated with multiplexed feedback included in the feedback codebook is one of:
a first value that indicates that a downlink message of the one or more downlink messages was successfully received during a downlink interval that is associated with the bit, or
a second value that indicates that a downlink message was not received or not scheduled during the downlink interval that is associated with the bit.

4. The UE of claim 2, wherein the single bit associated with bundled feedback included in the feedback codebook is one of:
a first value that indicates that each downlink message of the one or more downlink messages was successfully received during the one or more downlink intervals associated with the single bit, or
a second value that indicates that at least one downlink message of the one or more downlink messages was not received during the one or more downlink intervals associated with the single bit.

5. The UE of claim 1, wherein the configuration information indicates that the one or more downlink intervals and the uplink interval are part of a periodic time interval, and indicates that the feedback communication is periodically configured to be associated with the first type of feedback or the second type of feedback.

6. The UE of claim 1, wherein the one or more downlink intervals are associated with a set of component carriers and the one or more downlink messages are received in respective component carriers of the set of component carriers.

7. The UE of claim 6, wherein the configuration information indicates for the set of component carriers to each separately apply the first type of feedback or to each separately apply the second type of feedback.

8. The UE of claim 6, wherein the configuration information separately indicates, for each component carrier of the set of component carriers, whether to apply the first type of feedback or the second type of feedback.

9. The UE of claim 6, wherein the configuration information indicates one or more subsets of component carriers from the set of component carriers and separately indicates, for each subset of component carriers of the one or more subsets of component carriers, whether to apply the first type of feedback or the second type of feedback.

10. The UE of claim 6, wherein the configuration information indicates for the feedback communication to include the single feedback indication for the one or more downlink messages across the set of component carriers.

11. The UE of claim 1, wherein the one or more downlink intervals are included in a downlink time segment of multiple downlink time segments that span a downlink time window.

12. The UE of claim 11, wherein the configuration information separately indicates, for each downlink time segment of the multiple downlink time segments, whether the feedback communication is associated with first type of feedback or the second type of feedback.

13. The UE of claim 11, wherein the second type of feedback is applied separately to the multiple downlink time segments.

14. The UE of claim 11, wherein the downlink time segment is associated with one or more of a subset of downlink time intervals included in the downlink time window, one or more component carriers of a set of component carriers associated with the downlink time window, or one or more codewords of a set of codewords associated with the downlink time window.

15. The UE of claim 1, wherein the one or more downlink intervals are associated with a time period that spans a downlink time window or spans a downlink time segment of the downlink time window, and wherein one or more processors are further configured to cause the UE to:
receive, from the network node, control information that schedules a single downlink message of the one or more downlink messages during the time period, wherein receiving the single downlink message is in accordance with the configuration information.

16. The UE of claim 1, wherein the one or more downlink intervals are associated with a time period that spans a downlink time window or spans a downlink time segment of the downlink time window, and wherein one or more processors are further configured to cause the UE to:
receive, from the network node, a single downlink grant that schedules one or more downlink messages of the one or more downlink messages during the time period, wherein receiving the single downlink grant is in accordance with the configuration information.

17. The UE of claim 1, wherein the one or more downlink messages are one or more physical downlink shared channel (PDSCH) transport blocks, the one or more downlink intervals are one or more downlink slots, and the feedback communication is a Type-1 hybrid automatic repeat request (HARQ) codebook communication.

18. The UE of claim 1, wherein the one or more downlink messages are one or more code block groups included in a physical downlink shared channel (PDSCH) transport block, the one or more downlink intervals are one or more portions of a slot associated with the PDSCH transport block, and the feedback communication is a code block group (CBG) feedback communication associated with a Type-1 hybrid automatic repeat request (HARQ) codebook.

19. A network node for wireless communication, comprising:
one or more memories; and
one or more processors, coupled to the one or more memories, configured to cause the network node to:
transmit, to a user equipment (UE), configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval;
transmit, to the UE during the one or more downlink intervals, a one or more downlink messages; and
receive, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

20. The network node of claim 19, wherein the feedback communication includes a feedback codebook having a fixed size, and wherein the feedback codebook includes one or more of:
multiplexed feedback associated with the first type of feedback, wherein downlink intervals of the one or more downlink intervals are associated with respective bits included in the feedback codebook, or
bundled feedback associated with the second type of feedback, wherein the one or more downlink messages scheduled during the one or more downlink intervals are associated with a single bit included in the feedback codebook.

21. The network node of claim 20, wherein a bit associated with multiplexed feedback included in the feedback codebook is one of:
a first value that indicates that a downlink message of the one or more downlink messages was successfully received during a downlink interval associated with the bit, or
a second value that indicates that a downlink message was not received or not scheduled during the downlink interval that is associated with the bit.

22. The network node of claim 20, wherein the single bit associated with bundled feedback included in the feedback codebook is one of:
a first value that indicates that each downlink message of the one or more downlink messages was successfully received during the one or more downlink intervals associated with the single bit, or
a second value that indicates that at least one downlink message of the one or more downlink messages was not received during the one or more downlink intervals associated with the single bit.

23. The network node of claim 19, wherein the configuration information indicates that the one or more downlink intervals and the uplink interval are part of a periodic time interval and indicates that the feedback communication is periodically configured to be associated with the first type of feedback or the second type of feedback.

24. The network node of claim 19, wherein the one or more downlink intervals are associated with a set of component carriers and the one or more downlink messages are received in respective component carriers of the set of component carriers.

25. The network node of claim 24, wherein the configuration information indicates for the set of component carriers to each separately apply the first type of feedback or to each separately apply the second type of feedback.

26. The network node of claim 24, wherein the configuration information separately indicates, for each component carrier of the set of component carriers, whether to apply the first type of feedback or the second type of feedback.

27. The network node of claim 24, wherein the configuration information indicates one or more subsets of component carriers from the set of component carriers and separately indicates, for each subset of component carriers of the one or more subsets of component carriers, whether to apply the first type of feedback or the second type of feedback.

28. The network node of claim 24, wherein the configuration information indicates for the feedback communication to include the single feedback indication for the one or more downlink messages across the set of component carriers.

29. A method of wireless communication performed by a user equipment (UE), comprising:
receiving, from a network node, configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval;
receiving, from the network node during the one or more downlink intervals, one or more downlink messages; and
transmitting, to the network node during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.

30. A method of wireless communication performed by a network node, comprising:
transmitting, to a user equipment (UE), configuration information that indicates whether a feedback communication, that is scheduled during an uplink interval, is associated with a first type of feedback or a second type of feedback, wherein the feedback communication is associated with data received during one or more downlink intervals, and wherein the configuration information is specific to the uplink interval;
transmitting, to the UE during the one or more downlink intervals, a one or more downlink messages; and
receiving, from the UE during the uplink interval, the feedback communication, wherein the feedback communication includes respective one or more feedback indications associated with the one or more downlink messages in accordance with the first type of feedback or a single feedback indication associated with the one or more downlink messages in accordance with the second type of feedback.
